(19) United States
(12) Patent Application Publication
(10) Pub. No.: US 2021/0237236 A1
(43) Pub. Date: Aug. 5, 2021

(54) ANTI-SLIP FASTENER DRIVER

(71) Applicant: Hong Ann Tool Industries Co., Ltd., Taichung City (TW)

(72) Inventor: Cheng-Wei SU, Taichung City (TW)

(21) Appl. No.: 17/141,244

(22) Filed: Jan. 5, 2021

(30) Foreign Application Priority Data
Feb. 5, 2020 (TW) 109103535
Oct. 5, 2020 (TW) 109134445
Nov. 19, 2020 (TW) 109140586

(51) Int. Cl. B25B 23/10; B25B 15/02; B25B 15/00

(52) U.S. Cl. CPC B25B 23/105; B25B 15/004; B25B 15/02

(57) ABSTRACT

An anti-slip fastener driver includes a shank and a driving portion formed on an end of the shank and defining a longitudinal axis. The driving portion includes an outer periphery surrounding the longitudinal axis and having a first peripheral face. An end of the driving portion opposite to the shank includes a first end face connected to the first peripheral face. The first end face includes a first side and a first angle located outside of the first side. The end of the driving portion opposite to the shank includes a reference plane perpendicular to the longitudinal axis. The first side is located on the reference plane. An end of the first side is adjacent to the longitudinal axis. Another end of the first side opposite to the longitudinal axis is connected to the first peripheral face. The first angle is located between the reference plane and the shank.

### BACKGROUND OF THE INVENTION

The present invention relates to a fastener driver and, more particularly, to an anti-slip fastener driver.

A conventional fastener driver, such as a hexagonal wrench, a screwdriver, etc. is a hand tool that is usually used to driver a fastener, such as a bolt or a screw. Considering the costs and the fact that the fasteners are common expendables, the fasteners are generally made of materials softer than the fastener drivers, resulting in wear of the fasteners while being driven by the fastener drivers. Furthermore, a fastener forcibly driven by a fastener driver of a size not matching with the fastener will wear, too. The wear of a fastener result in damage to a driving hole of the fastener. In a case that the driving hole of the fastener becomes a nearly circular hole, when the fastener driver engages with the driving hole and rotates to drive the fastener, the fastener driver slips relative to the fastener, failing to effectively drive the fastener.

In view of the above drawbacks of the conventional structure, Applicant has designed an anti-slip fastener driver that mitigates and/or obviates the above disadvantages.

### BRIEF SUMMARY OF THE INVENTION

In a first aspect of the present invention, an anti-slip fastener driver comprises a shank and a driving portion formed on an end of the shank and defining a longitudinal axis. The driving portion includes an outer periphery surrounding the longitudinal axis and having a first peripheral face. An end of the driving portion opposite to the shank includes a first end face connected to the first peripheral face. The first end face includes a first side and a first angle located outside of the first side. The end of the driving portion opposite to the shank includes a reference plane perpendicular to the longitudinal axis. The first side is located on the reference plane. An end of the first side is adjacent to the longitudinal axis. Another end of the first side opposite to the longitudinal axis is connected to the first peripheral face. The first angle is located between the reference plane and the shank.

In an example, the first peripheral face extends in a direction parallel to the longitudinal axis. The first end face is connected to a first driving face extending in a direction parallel to the longitudinal axis. The first driving face is connected to the first angle. The first driving face includes an angle located on the longitudinal axis. A side of the first driving face distant to the first end face is located on the reference plane.

In an example, the outer periphery of the driving portion surrounding the longitudinal axis further includes a second peripheral face extending in a direction parallel to the longitudinal axis. The end of the driving portion opposite to the shank includes a second end face connected to the second peripheral face. The second peripheral face is contiguous to the first peripheral face. The second end face includes a second side and a second angle located outside of the second side. The second side is located on the reference plane and is connected to the first driving face. The end of the first side adjacent to the longitudinal axis has an end point located on the longitudinal axis. An end of the second side is connected to the first side. An interconnection between the first side and the second side is located on the longitudinal axis. Another end of the second side opposite to the longitudinal axis is connected to the second peripheral face. The second angle is located between the reference plane and the shank.

In an example, the outer periphery of the driving portion surrounding the longitudinal axis further includes a third peripheral face, a fourth periphery face, a fifth peripheral face, and a sixth peripheral face. Each of the third, fourth, fifth, and sixth peripheral faces extends in a direction parallel to the longitudinal axis.

The end of the driving portion opposite to the shank includes a third end face, a fourth end face, a fifth end face, and a sixth end face. The third end face is connected to the third peripheral face. The third peripheral face is contiguous to the second peripheral face and is located on a side of the second peripheral face opposite to the first peripheral face. The third end face includes a third side and a third angle located outside of the third side. The third side is located on the reference plane. An end of the third side is connected to the first side. An interconnection between the first side and the third side is located on the longitudinal axis. Another end of the third side opposite to the longitudinal axis is connected to the third peripheral face. The third angle is located between the reference plane and the shank.

The fourth end face is connected to the fourth peripheral face. The fourth peripheral face is contiguous to the third peripheral face and is located on a side of the third peripheral face opposite to the second peripheral face. The fourth peripheral face is parallel to the first peripheral face. The fourth end face includes a fourth side and a fourth angle located outside of the fourth side. The fourth side is located on the reference plane. An end of the fourth side is connected to the first side. The first side and the fourth side are located on the same line. An interconnection between the first side and the fourth side is located on the longitudinal axis. Another end of the fourth side opposite to the longitudinal axis is connected to the fourth peripheral face. The fourth angle is located between the reference plane and the shank.

The fifth end face is connected to the fifth peripheral face. The fifth peripheral face is contiguous to the fourth peripheral face and is located on a side of the fourth peripheral face opposite to the third peripheral face. The fifth peripheral face is parallel to the second peripheral face. The fifth end face includes a fifth side and a fifth angle located outside of the fifth side. The fifth side is located on the reference plane. An end of the fifth side is connected to the second side. An intersection between the second side and the fifth side is located on the longitudinal axis. Another end of the fifth side opposite to the longitudinal axis is connected to the fifth peripheral face. The fifth angle is located between the reference plane and the shank.

The sixth end face is connected to the sixth peripheral face. The sixth peripheral face is located between the first peripheral face and the fifth peripheral face. The sixth peripheral face is parallel to the third peripheral face. The sixth end face includes a sixth side and a sixth angle located outside of the sixth side. The sixth side is located on the reference plane. An end of the sixth side is connected to the third side. The third side and the sixth side are on the same line. An interconnection between the third side and the sixth side is located on the longitudinal axis. Another end of the sixth side opposite to the longitudinal axis is connected to the sixth peripheral face. The sixth angle is located between the reference plane and the shank.

The third end face is connected to a second driving face extending in a direction parallel to the longitudinal axis. The second driving face is connected to the third angle. The second driving face has an angle located on the longitudinal axis. A side of the second driving face distant to the third end face is located on the reference plane. The fourth side is connected to the second driving face. The fifth end face is connected to a third driving face extending in a direction parallel to the longitudinal axis. The third driving face is connected to the fifth angle. The third driving face has an angle located on the longitudinal axis. A side of the third driving face distant to the fifth end face is located on the reference plane. The sixth side is connected to the third driving face.

The second end face is connected to a fourth driving face extending in a direction parallel to the longitudinal axis. The fourth driving face is connected to the second angel. The fourth driving face has an angle located on the longitudinal axis. A side of the fourth driving face distant to the second end face is located on the reference plane. The third side is connected to the fourth driving face. The fourth end face is connected to a fifth driving face extending in a direction parallel to the longitudinal axis. The fifth driving face is connected to the fourth angle. The fifth driving face has an angle located on the longitudinal axis. A side of the fifth driving face distant to the fourth end face is located on the reference plane. The fifth side is connected to the fifth driving face. The sixth end face is connected to a sixth driving face extending in a direction parallel to the longitudinal axis. The sixth driving face is connected to the sixth angle. The sixth driving face has an angle located on the longitudinal axis. A side of the sixth driving face distant to the sixth end face is located on the reference plane. The first side is connected to the sixth driving face.

In an example, each of the first, second, third, fourth, fifth, and sixth end faces is a slant face at a non-parallel angle to the reference plane.

In an example, the outer periphery of the driving portion surrounding the longitudinal axis further includes a second peripheral face extending in a direction parallel to the longitudinal axis. The end of the driving portion opposite to the shank includes a second end face connected to the second peripheral face. The second peripheral face is contiguous to the first peripheral face. The second end face includes a second side and a second angle located outside of the second side. The second end face is a planar face extending perpendicularly to the reference plane. The second side and the second angel are located on the reference plane. The end of the first side adjacent to the longitudinal axis has an end point located on the longitudinal axis. An end of the second side is connected to the first side. An interconnection between the first side and the second side is located on the longitudinal axis. Another end of the second side opposite to the longitudinal axis is connected to the second peripheral side.

In an example, the outer periphery of the driving portion surrounding the longitudinal axis further includes a third peripheral face, a fourth peripheral face, a fifth peripheral face, and a sixth peripheral face. Each of the third, fourth, fifth, and sixth peripheral faces extends in a direction parallel to the longitudinal axis.

The end of the driving portion opposite to the shank includes a third end face, a fourth end face, a fifth end face, and a sixth end face. The third end face is connected to the third peripheral face. The third peripheral face is contiguous to the second peripheral face and is located on a side of the second peripheral face opposite to the first peripheral face. The third end face includes a third side and a third angle located outside of the third side. The third side is located on the reference plane. The third side is connected to the second end face. An end of the third side is connected to the first side. An interconnection between the first side and the third side is located on the longitudinal axis. Another end of the third side opposite to the longitudinal axis is connected to the third peripheral face. The third angle is located between the reference plane and the shank.

The fourth end face is connected to the fourth peripheral face. The fourth peripheral face is contiguous to the third peripheral face and is located on a side of the third peripheral face opposite to the second peripheral face. The fourth peripheral face is parallel to the first peripheral face. The fourth end face includes a fourth side and a fourth angle located outside of the fourth side. The fourth peripheral face is a planar face extending perpendicularly to the longitudinal axis. The fourth side and fourth angle are located on the reference plane. An end of the fourth side is connected to the first side. The first side and the fourth side are located on the same line. An interconnection between the first side and the fourth side is located on the longitudinal axis. Another end of the fourth side opposite to the longitudinal axis is connected to the fourth peripheral face. The fourth angle is located between the reference plane and the shank.

The fifth end face is connected to the fifth peripheral face. The fifth peripheral face is contiguous to the fourth peripheral face and is located on a side of the fourth peripheral face opposite to the third peripheral face. The fifth peripheral face is parallel to the second peripheral face. The fifth end face includes a fifth side and a fifth angle located outside of the fifth side. The fifth side is located on the reference plane. The fifth side is connected to the fourth end face. An end of the fifth side is connected to the second side. An intersection between the second side and the fifth side is located on the longitudinal axis. Another end of the fifth side opposite to the longitudinal axis is connected to the fifth peripheral face. The fifth angle is located between the reference plane and the shank.

The sixth end face is connected to the sixth peripheral face. The sixth peripheral face is located between the first peripheral face and the fifth peripheral face. The sixth peripheral face is parallel to the third peripheral face. The first side is connected to the sixth end face. The sixth end face includes a sixth side and a sixth angle located outside of the sixth side. The sixth end face is a planar face extending perpendicularly to the longitudinal axis. The sixth side and the sixth angle are located on the reference plane. An end of the sixth side is connected to the third side. The third side and the sixth side are on the same line. An interconnection between the third side and the sixth side is located on the longitudinal axis. Another end of the sixth side opposite to the longitudinal axis is connected to the sixth peripheral face. The sixth angle is located between the reference plane and the shank.

The third end face is connected to a second driving face extending in a direction parallel to the longitudinal axis. The second driving face is connected to the third angle. The second driving face has an angle located on the longitudinal axis. A side of the second driving face distant to the third end face is located on the reference plane. The fourth side is connected to the second driving face. The fifth end face is connected to a third driving face extending in a direction parallel to the longitudinal axis. The third driving face is connected to the fifth angle. The third driving face has an angle located on the longitudinal axis. A side of the third driving face distant to the fifth end face is located on the reference plane. The sixth side is connected to the third driving face.

In an example, each of the first end face, the third end face, and the fifth end face is a slant face at a non-parallel angle to the reference plane.

In an example, the end of the first side adjacent to the longitudinal axis has an end point not located on the longitudinal axis. The first end face is connected to a first driving face extending in a direction parallel to the longitudinal axis. The first driving face is connected to a first angle. The first driving face does not intersect with the longitudinal axis. A side of the first driving face distant to the first end face is located on the reference plane.

In an example, the outer periphery of the driving portion surrounding the longitudinal axis further includes a second peripheral face extending in a direction parallel to the longitudinal axis. The end of the driving portion opposite to the shank further includes a second end face connected to the second peripheral face. The second peripheral face is contiguous to the first peripheral face. The second end face includes a second side and a second angle located outside of the second side. The second side is located on the reference plane. An end of the second side is adjacent to the longitudinal axis and has an end point not located on the longitudinal axis. Another end of the second side opposite to the longitudinal axis is connected to the second peripheral side. The second angle is located between the reference plane and the shank.

In an example, the outer periphery of the driving portion surrounding the longitudinal axis includes a third peripheral face, a fourth peripheral face, a fifth peripheral face, and a sixth peripheral face. Each of the third peripheral face, the fourth peripheral face, the fifth peripheral face, and the sixth peripheral face extends in a direction parallel to the longitudinal axis.

The end of the driving portion opposite to the shank includes a third end face, a fourth end face, a fifth end face, and a sixth end face. The third end face is connected to the third peripheral face. The third peripheral face is contiguous to the second peripheral face and is located on a side of the second peripheral face opposite to the first peripheral face. The third end face includes a third side and a third angle located outside of the third side. The third side is located on the reference plane. An end of the third side adjacent to the longitudinal axis has an end point located outside of the longitudinal axis. Another end of the third side opposite to the longitudinal axis is connected to the third peripheral face. The third angle is located between the reference plane and the shank.

The fourth end face is connected to the fourth peripheral face. Te fourth peripheral face is contiguous to the third peripheral face and is located on a side of the third peripheral face opposite to the second peripheral face. The fourth peripheral face is parallel to the first peripheral face. The fourth end face includes a fourth side and a fourth angle located outside of the fourth side. The fourth side is located on the reference plane. An end of the fourth side adjacent to the longitudinal axis has an end point is located outside of the longitudinal axis. Another end of the fourth side opposite to the longitudinal axis is connected to the fourth peripheral face. The fourth angle is located between the reference plane and the shank.

The fifth end face is connected to the fifth peripheral face. The fifth peripheral face is contiguous to the fourth peripheral face and is located on a side of the fourth peripheral face opposite to the third peripheral face. The fifth peripheral face is parallel to the second peripheral face. The fifth end face includes a fifth side and a fifth angle located outside of the fifth side. The fifth side is located on the reference plane. An end of the fifth side is adjacent to the longitudinal axis and has an end point located outside of the longitudinal axis. Another end of the fifth side opposite to the longitudinal axis is connected to the fifth peripheral face. The fifth angle is located between the reference plane and the shank.

The sixth end face is connected to the sixth peripheral face. The sixth peripheral face is located between the first peripheral face and the fifth peripheral face. The sixth peripheral face is parallel to the third peripheral face. The sixth end face includes a sixth side and a sixth angle located outside of the sixth side. The sixth side is located on the reference plane. An end of the sixth side is adjacent to the longitudinal axis and has an end point located outside of the longitudinal axis. Another end of the sixth side opposite to the longitudinal axis is connected to the sixth peripheral face. The sixth angle is located between the reference plane and the shank.

The second end face is located on a side of the first driving face opposite to the first end face and is not connected to the first driving face. The second side is located on a side of the second end face adjacent to the first driving face. The third end face is connected to a second driving face extending in a direction parallel to the longitudinal axis. The second driving face is connected to the third angle. The second driving face does not intersect with the longitudinal axis. A side of the second driving face distant to the third end face is located on the reference plane. The fourth end face is located on a side of the second driving face opposite to the third end face and does not intersect with the second driving face. The fourth side is located on a side of the fourth end face adjacent to the second driving face. The fifth end face is connected to a third driving face extending in a direction parallel to the longitudinal axis. The third driving face is connected to the fifth angle. The third driving face does not intersect with the longitudinal axis. A side of the third driving face distant to the fifth end face is located on the reference plane. The sixth end face is located on a side of the third driving face opposite to the fifth end face and does not intersect with the third driving face. The sixth side is located on a side of the sixth end face adjacent to the third driving face.

The second end face is connected to a fourth driving face extending in a direction parallel to the longitudinal axis. The fourth driving face is connected to the second angel. The fourth driving face does not intersect with the longitudinal axis. A side of the fourth driving face distant to the second end face is located on the reference plane. The third end face is located on a side of the fourth driving face opposite to the first end face and does not intersect with the fourth driving face. The third side is located on a side of the third end face adjacent to the fourth driving face.

The fourth end face is connected to a fifth driving face extending in a direction parallel to the longitudinal axis. The fifth driving face is connected to the fourth angle and dose not intersect with the longitudinal axis. A side of the fifth driving face distant to the fourth end face is located on the reference plane. The fifth end face is located on a side of the fifth driving face opposite to the fourth end face and does not intersect with the fifth driving face.

The fifth side is located on a side of the fifth end face adjacent to the fifth driving face. The sixth end face is connected to a sixth driving face extending in a direction parallel to the longitudinal axis. The sixth driving face is connected to the sixth angle. The sixth driving face does not intersect with the longitudinal axis. A side of the sixth driving face distant to the sixth end face is located on the reference plane. The first end face is located on a side of the sixth driving face opposite to the sixth end face and does not intersect with the sixth driving face. The first side is located on a side of the first end face adjacent to the sixth driving face.

In an example, the end of the driving portion opposite to the shank includes a seventh end face. The seventh end face is a planar face extending perpendicularly to the longitudinal axis and is located on the reference plane. The seventh end face is connected to the first end face, the first driving face, the second end face, the second driving face, the third end face, the third driving face, the fourth end face, the fourth driving face, the fifth end face, the fifth driving face, the sixth end face, and the sixth driving face. An outer periphery of the seventh end face surrounding the longitudinal axis is connected to the first peripheral face, the second peripheral face, the third peripheral face, the fourth peripheral face, the fifth peripheral face, and the sixth peripheral face.

In an example, the end of the driving portion opposite to the shank includes a hole centered at the longitudinal axis and extending along the longitudinal axis. A side of the first end face opposite to the first peripheral face is connected to the hole. The end of the first side adjacent to the longitudinal axis and an end of the first driving face adjacent to the longitudinal axis are connected to the hole.

In an example, the outer periphery of the driving portion surrounding the longitudinal axis further includes a second peripheral face extending in a direction parallel to the longitudinal axis. The end of the driving portion opposite to the shank further includes a second end face connected to the second peripheral face. A side of the second end face opposite to the second peripheral face is connected to the hole. The second peripheral face is contiguous to the first peripheral face. The second end face includes a second side and a second angle located outside of the second side. The second side is located on the reference plane. An end of the second side is adjacent to the longitudinal axis and has an end point not located on the longitudinal axis. The end of the second side adjacent to the longitudinal axis is connected to the hole. Another end of the second side opposite to the longitudinal axis is connected to the second peripheral side. The second angle is located between the reference plane and the shank.

In an example, the outer periphery of the driving portion surrounding the longitudinal axis further includes a third peripheral face, a fourth periphery face, a fifth peripheral face, and a sixth peripheral face. Each of the third peripheral face, the fourth peripheral face, the fifth peripheral face, and the sixth peripheral face extends in a direction parallel to the longitudinal axis.

The end of the driving portion opposite to the shank further includes a third end face, a fourth end face, a fifth end face, and a sixth end face. The third end face is connected to the third peripheral face. The third peripheral face is contiguous to the second peripheral face and is located on a side of the second peripheral face opposite to the first peripheral face. The third end face includes a third side and a third angle located outside of the third side. The third side is located on the reference plane. An end of the third side is adjacent to the longitudinal axis and has an end not located on the longitudinal axis. Another end of the third side opposite to the longitudinal axis is connected to the third peripheral face. The third angle is located between the reference plane and the shank.

The fourth end face is connected to the fourth peripheral face. The fourth peripheral face is contiguous to the third peripheral face and is located on a side of the third peripheral face opposite to the second peripheral face. The fourth peripheral face is parallel to the first peripheral face. The fourth end face includes a fourth side and a fourth angle located outside of the fourth side. The fourth side is located on the reference plane. An end of the fourth side is adjacent to the longitudinal axis and has an end point not located on the longitudinal axis. Another end of the fourth side opposite to the longitudinal axis is connected to the fourth peripheral face. The fourth angle is located between the reference plane and the shank.

The fifth end face is connected to the fifth peripheral face. The fifth peripheral face is contiguous to the fourth peripheral face and is located on a side of the fourth peripheral face opposite to the third peripheral face. The fifth peripheral face is parallel to the second peripheral face. The fifth end face includes a fifth side and a fifth angle located outside of the fifth side. The fifth side is located on the reference plane. An end of the fifth side is adjacent to the longitudinal axis and has an end not located on the longitudinal axis. Another end of the fifth side opposite to the longitudinal axis is connected to the fifth peripheral face. The fifth angle is located between the reference plane and the shank.

The sixth end face is connected to the sixth peripheral face. The sixth peripheral face is located between the first peripheral face and the fifth peripheral face. The sixth peripheral face is parallel to the third peripheral face. The sixth end face includes a sixth side and a sixth angle located outside of the sixth side. The sixth side is located on the reference plane. An end of the sixth side is adjacent to the longitudinal axis and has an end point not located on the longitudinal axis. Another end of the sixth side opposite to the longitudinal axis is connected to the sixth peripheral face. The sixth angle is located between the reference plane and the shank.

The second end face is located on a side of the first driving face opposite to the first end face and does not intersect with the first driving face. The second side is located on a side of the second end face adjacent to the first driving face. The third end face is connected to a second driving face extending in a direction parallel to the longitudinal axis. The second driving face is connected to the third angle. The second driving face does not intersect with the longitudinal axis. A side of the second driving face distant to the third end face is located on the reference plane. The fourth side is located on a side of the second driving face opposite to the third end face and does not intersect with the second driving face. The fourth side is located on a side of the fourth end face adjacent to the second driving face. The fifth end face is connected to a third driving face extending in a direction parallel to the longitudinal axis. The third driving face is connected to the fifth angle. The third driving face does not intersect with the longitudinal axis. A side of the third driving face distant to the fifth end face is located on the reference plane. The sixth side is located on a side of the third driving face opposite to the fifth end face and does not intersect with the third driving face. The sixth side is located on a side of the sixth end face adjacent to the third driving face.

The second end face is connected to a fourth driving face extending in a direction parallel to the longitudinal axis. The fourth driving face is connected to the second angel. The fourth driving face does not intersect with the longitudinal axis. A side of the fourth driving face distant to the second end face is located on the reference plane. The third side is located on a side of the fourth driving face opposite to the first end face and does not intersect with the fourth driving face. The third side is located on a side of the third end face adjacent to the fourth driving face. The fourth end face is connected to a fifth driving face extending in a direction parallel to the longitudinal axis. The fifth driving face is connected to the fourth angle. The fifth driving face does not intersect with the longitudinal axis. A side of the fifth driving face distant to the fourth end face is located on the reference plane. The fifth end face is located on a side of the fifth driving face opposite to the fourth end face and does not intersect with the fifth driving face. The fifth side is located on a side of the fifth end face adjacent to the fifth driving face.

The sixth end face is connected to a sixth driving face extending in a direction parallel to the longitudinal axis. The sixth driving face is connected to the sixth angle and does not intersect with the longitudinal axis. A side of the sixth driving face distant to the sixth end face is located on the reference plane. The first end face is located on a side of the sixth driving face opposite to the sixth end face and does not intersect with the sixth driving face. The first side is located on a side of the first end face adjacent to the sixth driving face. An end of the fourth driving face adjacent to the longitudinal axis is connected to the hole. A side of the third end face opposite to the third peripheral face is connected to the hole. An end of the third side adjacent to the longitudinal axis and an end of the second driving face adjacent to the longitudinal axis are connected to the hole. A side of the fourth end face opposite to the fourth peripheral face is connected to the hole. An end of the fourth side adjacent to the longitudinal axis and an end of the fifth driving face adjacent to the longitudinal axis are connected to the hole. A side of the fifth end face opposite to the fifth peripheral face is connected to the hole. An end of the fifth side adjacent to the longitudinal axis and an end of the third driving face adjacent to the longitudinal axis are connected to the hole. A side of the sixth end face opposite to the sixth peripheral face is connected to the hole. An end of the sixth side adjacent to the longitudinal axis and an end of the sixth driving face adjacent to the longitudinal axis are connected to the hole.

In an example, the end of the driving portion opposite to the shank includes a seventh end face, an eighth end face, a ninth end face, a tenth end face, an eleventh end face, and a twelfth end face. Each of the seventh, eighth, ninth, tenth, eleventh, and twelfth end faces is a planar face extending perpendicularly to the longitudinal axis and is located on the reference plane.

The seventh end face is located on a side of the first end face opposite to the first driving face. An end of the seventh end face is connected to the hole. Another end of the seventh end face is connected to the first peripheral face. A side of the seventh end face is connected to the first end face. The first side is formed between the first end face and the seventh end face.

The eighth end face is located on a side of the second end face opposite to the fourth driving face. An end of the eighth end face is connected to the hole. Another end of the eighth end face is connected to the second peripheral face. A side of the eighth end face is connected to the second end face. The second side is formed between the second end face and the eighth end face.

The ninth end face is located on a side of the third end face opposite to the second driving face. An end of the ninth end face is connected to the hole. Another end of the ninth end face is connected to the third peripheral face. A side of the ninth end face is connected to the third end face. The third side is formed between the third end face and the ninth end face.

The tenth end face is located on a side of the fourth end face opposite to the fifth driving face. An end of the tenth end face is connected to the hole. Another end of the tenth end face is connected to the fourth peripheral face. A side of the tenth end face is connected to the fourth end face. The fourth side is formed between the fourth end face and the tenth end face.

The eleventh end face is located on a side of the fifth end face opposite to the third driving face. An end of the eleventh end face is connected to the hole. Another end of the eleventh end face is connected to the fifth peripheral face. A side of the eleventh end face is connected to the fifth end face. The fifth side is formed between the fifth end face and the eleventh end face.

The twelfth end face is located on a side of the sixth end face opposite to the sixth driving face. An end of the twelfth end face is connected to the hole. Another end of the twelfth end face is connected to the sixth peripheral face. A side of the twelfth end face is connected to the sixth end face. The sixth side is formed between the sixth end face and the twelfth end face.

In an example, the first peripheral face has a lateral width in a radial direction perpendicular to the longitudinal axis. An end of the first side adjacent to the longitudinal axis and another end of the first side connected to the first peripheral face have a first length therebetween. The first length is smaller than 0.5 times the lateral width.

In an example, the first peripheral face has a lateral width in a radial direction perpendicular to the longitudinal axis. An end of the first side adjacent to the longitudinal axis and another end of the first side connected to the first peripheral face have a first length therebetween. An end of the second side adjacent to the longitudinal axis and another end of the second side connected to the second peripheral face have a second length therebetween. An end of the third side adjacent to the longitudinal axis and another end of the third side connected to the third peripheral face have a third length therebetween. An end of the fourth side adjacent to the longitudinal axis and another end of the fourth side connected to the fourth peripheral face have a fourth length therebetween. An end of the fifth side adjacent to the longitudinal axis and another end of the fifth side connected to the fifth peripheral face have a fifth length therebetween. An end of the sixth side adjacent to the longitudinal axis and another end of the sixth side connected to the sixth peripheral face have a sixth length therebetween. Each of the first length, the second length, the third length, the fourth length, the fifth length, and the sixth length is smaller than 0.5 times the lateral width.

In an example, a side of the first driving face connected to the seventh end face intersects with the first side. The side of the first driving face and the first side have a first angle therebetween. A side of the fourth driving face connected to the seventh end face intersects with the second side. The side of the fourth driving face and the second side have a second angle therebetween. A side of the second driving face connected to the seventh end face intersects with the third side. The side of the second driving face and the third side have a third angle therebetween. A side of the fifth driving face connected to the seventh end face intersects with the fourth side. The side of the fifth driving face and the fourth side have a fourth angle therebetween. A side of the third driving face connected to the seventh end face intersects with the fifth side. The side of the third driving face and the fifth side have a fifth angle therebetween. A side of the sixth driving face connected to the seventh end face intersects with the sixth side. The side of the sixth driving face and the sixth side have a sixth angle therebetween. Each of the first angle, the second angle, the third angle, the fourth angle, the fifth angle, and the sixth angle is larger than 80°.

In an example, the end of the first side adjacent to the longitudinal axis has an end point not located on the longitudinal axis, and the first driving face does not intersect with the first side.

In an example, the outer periphery of the driving portion surrounding the longitudinal axis further includes a second peripheral face extending in a direction parallel to the longitudinal axis. The end of the driving portion opposite to the shank further includes a second end face connected to the second peripheral face. The second peripheral face is contiguous to the first peripheral face. The second end face includes a second side and a second angle located outside of the second side. An end of the first side is adjacent to the longitudinal axis and has an end point not located on the longitudinal axis. The end of the second side adjacent to the longitudinal axis is connected to the first driving face. Another end of the second side opposite to the longitudinal axis is connected to the second peripheral side. The second angle is located between the reference plane and the shank.

In an example, the outer periphery of the driving portion surrounding the longitudinal axis further includes a third peripheral face, a fourth peripheral face, a fifth peripheral face, and a sixth peripheral face. Each of the third peripheral face, the fourth peripheral face, the fifth peripheral face, and the sixth peripheral face extends in a direction parallel to the longitudinal axis.

The end of the driving portion opposite to the shank includes a third end face, a fourth end face, a fifth end face, and a sixth end face. The third end face is connected to the third peripheral face. The third peripheral face is contiguous to the second peripheral face and is located on a side of the second peripheral face opposite to the first peripheral face. The third end face includes a third side and a third angle located outside of the third side. The third side is located on the reference plane. An end of the third side is adjacent to the longitudinal axis and has an end point not located on the longitudinal axis. Another end of the third side opposite to the longitudinal axis is connected to the third peripheral face. The third angle is located between the reference plane and the shank.

The fourth end face is connected to the fourth peripheral face. The fourth peripheral face is contiguous to the third peripheral face and is located on a side of the third peripheral face opposite to the second peripheral face. The fourth peripheral face is parallel to the first peripheral face. The fourth end face includes a fourth side and a fourth angle located outside of the fourth side. The fourth side is located on the reference plane. An end of the fourth side is adjacent to the longitudinal axis and has an end point not located on the longitudinal axis. Another end of the fourth side opposite to the longitudinal axis is connected to the fourth peripheral face. The fourth angle is located between the reference plane and the shank.

The fifth end face is connected to the fifth peripheral face. The fifth peripheral face is contiguous to the fourth peripheral face and is located on a side of the fourth peripheral face opposite to the third peripheral face. The fifth peripheral face is parallel to the second peripheral face. The fifth end face includes a fifth side and a fifth angle located outside of the fifth side. The fifth side is located on the reference plane. An end of the fifth side is adjacent to the longitudinal axis and has an end point not located on the longitudinal axis. Another end of the fifth side opposite to the longitudinal axis is connected to the fifth peripheral face. The fifth angle is located between the reference plane and the shank.

The sixth end face is connected to the sixth peripheral face. The sixth peripheral face is located between the first peripheral face and the fifth peripheral face. The sixth peripheral face is parallel to the third peripheral face. The sixth end face includes a sixth side and a sixth angle located outside of the sixth side. The sixth side is located on the reference plane. An end of the sixth side is adjacent to the longitudinal axis and has an end point not located on the longitudinal axis. Another end of the sixth side opposite to the longitudinal axis is connected to the sixth peripheral face. The sixth angle is located between the reference plane and the shank.

The third end face is connected to a second driving face extending in a direction parallel to the longitudinal axis. The second driving face is connected to the third angle. The second driving face has an angle located on the longitudinal axis. A side of the second driving face distant to the third end face is located on the reference plane. An end of the fourth side adjacent to the longitudinal axis is connected to the second driving face. The second driving face does not intersect with the third side. The fifth end face is connected to a third driving face extending in a direction parallel to the longitudinal axis. The third driving face is connected to the fifth angle. The third driving face has an angle located on the longitudinal axis. A side of the third driving face distant to the fifth end face is located on the reference plane. An end of the sixth side adjacent to the longitudinal axis is connected the third driving face. The third driving face does not intersect with the fifth side.

The second end face is connected to a fourth driving face extending in a direction parallel to the longitudinal axis. The fourth driving face is connected to the second angel. The fourth driving face has an angle located on the longitudinal axis. A side of the fourth driving face distant to the second end face is located on the reference plane. An end of the third side adjacent to the longitudinal axis is connected to the fourth driving face. The fourth driving face does not intersect with the second side. The fourth end face is connected to a fifth driving face extending in a direction parallel to the longitudinal axis. The fifth driving face is connected to the fourth angle. The fifth driving face has an angle located on the longitudinal axis. A side of the fifth driving face distant to the fourth end face is located on the reference plane. An end of the fifth side adjacent to the longitudinal axis is connected to the fifth driving face. The fifth driving face does not intersect with the fourth side. The sixth end face is connected to a sixth driving face extending in a direction parallel to the longitudinal axis. The sixth driving face is connected to the sixth angle. The sixth driving face has an angle located on the longitudinal axis. A side of the sixth driving face distant to the sixth end face is located on the reference plane. The end of the first side adjacent to the longitudinal axis is connected to the sixth driving face. The sixth driving face does not intersect with the sixth side.

In an example, the end of the driving portion opposite to the shank includes a seventh end face, an eighth end face, a ninth end face, a tenth end face, an eleventh end face, and a twelfth end face. Each of the seventh, eighth, ninth, tenth, eleventh, and twelfth end faces is a planar face extending perpendicularly to the longitudinal axis and is located on the reference plane. The seventh end face is connected to the first peripheral face, the first end face, and the sixth driving face. The first side is formed between the first end face and the seventh end face. The eighth end face is connected to the second peripheral face, the second end face, and the first driving face. The second side is formed between the second end face and the eighth end face. The ninth end face is connected to the third peripheral face, the third end face, and the fourth driving face. The third side is formed between the third end face and the ninth end face. The tenth end face is connected to the fourth peripheral face, the fourth end face, and the second driving face. The fourth side is formed between the fourth end face and the tenth end face. The eleventh end face is connected to the fifth peripheral face, the fifth end face, and the fifth driving face. The fifth side is formed between the fifth end face and the eleventh end face. The twelfth end face is connected to the sixth peripheral face, the sixth end face, and the third driving face. The sixth side is formed between the sixth end face and the twelfth end face.

In an example, each two adjacent ones of the first, second, third, fourth, fifth, and sixth peripheral faces have an inner angle of 120° therebetween.

In a second aspect of the present invention, an anti-slip fastener driver comprises a shank and a driving portion formed on an end of the shank and defining a longitudinal axis. The driving portion includes an outer periphery surrounding the longitudinal axis and having a first peripheral face, a second peripheral face, and a third peripheral face. An end of the driving portion opposite to the shank includes an end face connected to the first, second, and third peripheral faces. The second peripheral face is contiguous to the first peripheral face. The third peripheral face is contiguous to the second peripheral face and is located on a side of the second peripheral face opposite to the first peripheral face. The end face includes a first angle and a second angle. The first angle is located on an intersection between the first peripheral face and the second peripheral face. The second angle is located between an intersection between the second peripheral face and the third peripheral face. The driving portion includes a first groove. An end of the first groove is connected to the end face. Another end of the first groove is connected to the second peripheral face. The end of the first groove connected to the end face forms a first edge. An end of the first edge has an end point located on the second angle. The first edge does not intersect with the first angle.

In an example, the outer periphery of the driving portion surrounding the longitudinal axis further includes a fourth peripheral face, a fifth peripheral face, and a sixth peripheral face. Each of the first, second, third, fourth, fifth, and sixth peripheral faces extends in a direction parallel to the longitudinal axis. The end face is connected to the first, second, third, fourth, fifth, and sixth peripheral faces. The fourth peripheral face is contiguous to the third peripheral face and is located on a side of the third peripheral face opposite to the second peripheral face. The fourth peripheral face is parallel to the first peripheral face. The fifth peripheral face is contiguous to the fourth peripheral face and is located on a side of the fourth peripheral face opposite to the third peripheral face. The fifth peripheral face is parallel to the second peripheral face. The sixth peripheral face is located between the first peripheral face and the fifth peripheral face. The sixth peripheral face is parallel to the third peripheral face.

The end face further includes a third angle, a fourth angle, a fifth angle, and a sixth angle. The third angle is located on an intersection between the third peripheral face and the fourth peripheral face. The fourth angle is located on an intersection between the fourth peripheral face and the fifth peripheral face. The fifth angle is located on an intersection between the third peripheral face and the sixth peripheral face. The sixth angle is located on an intersection between the sixth peripheral face and the first peripheral face.

The driving portion further includes a second groove and a third groove. An end of the second groove is connected to the end face. Another end of the second groove is connected to the fourth peripheral face. The end of the second groove connected to the end face forms a second edge. An end of the second edge is located on the fourth angle. The second edge does not intersect with the third angle. An end of the third groove is connected to the end face. Another end of the third groove is connected to the sixth peripheral face. The end of the third groove connected to the end face forms a third edge. An end of the third edge has an end point located on the sixth angle. The second edge does not intersect with the fifth angle.

In an example, the driving portion further includes a fourth groove, a fifth groove, and a sixth groove. An end of the fourth groove is connected to the end face. Another end of the fourth groove is connected to the first peripheral face. The end of the fourth groove connected to the end face forms a fourth edge. An end of the fourth edge has an end point located on the first angle. The fourth edge does not intersect with the sixth angle. An end of the fifth groove is connected to the end face. Another end of the fifth groove is connected to the third peripheral face. The end of the fifth groove connected to the end face forms a fifth edge. An end of the fifth edge is located on the third angle. The fifth edge does not intersect with the second angle. An end of the sixth groove is connected to the end face. Another end of the sixth groove is connected to the fifth peripheral face. The end of the sixth groove connected to the end face forms a sixth edge. An end of the sixth edge has an end point located on the fifth angle. The sixth edge does not intersect with the fourth angle.

In an example, each two adjacent ones of the first, second, third, fourth, fifth, and sixth peripheral faces have an inner angle of 120° therebetween. The first, second, third, fourth, fifth, and sixth edges are not connected to each other. Each of the first, second, third, fourth, fifth, and sixth edges is arcuate.

In a third aspect of the present invention, an anti-slip fastener driver comprises a shank and a driving portion formed on an end of the shank and defining a longitudinal axis. The driving portion includes an outer periphery surrounding the longitudinal axis and having a first peripheral face. An end of the driving portion opposite to the shank includes a front conical face and a first end face. The front conical face is a conical face centered at the longitudinal axis. The first end face is connected to the first peripheral face. The first end face includes a first side and a first angle not located on the first side. The first side is located on the front conical face. An end of the first side is adjacent to the longitudinal axis. Another end of the first side opposite to the longitudinal axis is connected to the first peripheral face. The first angle is located between the front conical face and the shank along the longitudinal axis.

In an example, the first peripheral face extending in a direction parallel to the longitudinal axis. An end of the first side adjacent to the longitudinal axis has an end point not locate don the longitudinal axis. The first end face is connected to a first driving face extending in a direction parallel to the longitudinal axis. The first driving face is connected to the first angle. The first driving face does not intersect with the longitudinal axis. A side of the first driving face distant to the first end face is located on the front conical face.

In an example, the outer periphery of the driving portion surrounding the longitudinal axis further includes a second peripheral face extending in a direction parallel to the longitudinal axis. The end of the driving portion opposite to the shank further includes a second end face connected to the second peripheral face. The second peripheral face is contiguous to the first peripheral face. The second end face includes a second side and a second angle located outside of the second side. The second side is located on the front conical face. An end of the second side is adjacent to the longitudinal axis and has an end point not located on the longitudinal axis. Another end of the second side opposite to the longitudinal axis is connected to the second peripheral face. The second angle is located between the front conical face and the shank along the longitudinal axis.

In an example, the outer periphery of the driving portion surrounding the longitudinal axis further includes a third peripheral face, a fourth peripheral face, a fifth peripheral face, and a sixth peripheral face. Each of the third, fourth, fifth, and sixth peripheral faces extends in a direction parallel to the longitudinal axis.

The end of the driving portion opposite to the shank further includes a third end face, a fourth end face, a fifth end face, and a sixth end face. The third end face is connected to the third peripheral face. The third peripheral face is contiguous to the second peripheral face and is located on a side of the second peripheral face opposite to the first peripheral face. The third end face includes a third side and a third angle located outside of the third side. The third side is located on the front conical face. An end of the third side is adjacent to the longitudinal axis and has an end point not located on the longitudinal axis. Another end of the third side opposite to the longitudinal axis is connected to the third peripheral face. The third angle is located between the front conical face and the shank along the longitudinal axis.

The fourth end face is connected to the fourth peripheral face. The fourth peripheral face is contiguous to the third peripheral face and is located on a side of the third peripheral face opposite to the second peripheral face. The fourth peripheral face is parallel to the first peripheral face. The fourth end face includes a fourth side and a fourth angle located outside of the fourth side. The fourth side is located on the front conical face. An end of the fourth side is adjacent to the longitudinal axis and has an end point not located on the longitudinal axis. Another end of the fourth side opposite to the longitudinal axis is connected to the fourth peripheral face. The fourth angle is located between the front conical face and the shank along the longitudinal axis.

The fifth end face is connected to the fifth peripheral face. The fifth peripheral face is contiguous to the fourth peripheral face and is located on a side of the fourth peripheral face opposite to the third peripheral face. The fifth peripheral face is parallel to the second peripheral face. The fifth end face includes a fifth side and a fifth angle located outside of the fifth side. The fifth side is located on the front conical face. An end of the fifth side is adjacent to the longitudinal axis and has an end point not located on the longitudinal axis. Another end of the fifth side opposite to the longitudinal axis is connected to the fifth peripheral face. The fifth angle is located between the front conical face and the shank along the longitudinal axis.

The sixth end face is connected to the sixth peripheral face. The sixth peripheral face is located between the first peripheral face and the fifth peripheral face. The sixth peripheral face is parallel to the third peripheral face. The sixth end face includes a sixth side and a sixth angle located outside of the sixth side. The sixth side is located on the front conical face. An end of the sixth side is adjacent to the longitudinal axis and has an end point not located on the longitudinal axis. Another end of the sixth side opposite to the longitudinal axis is connected to the sixth peripheral face. The sixth angle is located between the front conical face and the shank along the longitudinal axis. The second end face is located on a side of the first driving face opposite to the first end face and does not intersect with the first driving face. The second side is located on a side of the second end face adjacent to the first driving face.

The third end face is connected to a second driving face extending in a direction parallel to the longitudinal axis. The second driving face is connected to the third angle. The second driving face does not intersect with the longitudinal axis. A side of the second driving face distant to the third end face is located on the front conical face. The fourth end face is located on a side of the second driving face opposite to the third driving face and does not intersect with the second driving face. The fourth side is located on a side of the fourth end face adjacent to the second driving face.

The fifth end face is connected to a third driving face extending in a direction parallel to the longitudinal axis. The third driving face is connected to the fifth angle. The third driving face does not intersect with the longitudinal axis. A side of the third driving face distant to the fifth end face is located on the front conical face. The sixth end face is located on a side of the third driving face opposite to the fifth end face and dose not intersect with the third driving face. The sixth side is located on a side of the sixth end face adjacent to the third driving face.

The second end face is connected to a fourth driving face extending in a direction parallel to the longitudinal axis. The fourth driving face is connected to the second angle. The fourth driving face does not intersect with the longitudinal axis. A side of the fourth driving face distant to the second end face is located on the front conical face. The third end face is located on a side of the fourth driving face opposite to the first end face and does not intersect with the fourth driving face. The third side is located on a side of the third end face adjacent to the fourth driving face.

The fourth end face is connected to a fifth driving face extending in a direction parallel to the longitudinal axis. The fifth driving face is connected to the fourth angle. The fifth driving face does not intersect with the longitudinal axis. A side of the fifth driving face distant to the fourth end face is located on the front conical face. The fifth end face is located on a side of the fifth driving face opposite to the fourth end face and does not intersect with the fifth driving face. The fifth side is located on a side of the fifth end face adjacent to the fifth driving face.

The sixth end face is connected to a sixth driving face extending in a direction parallel to the longitudinal axis. The sixth driving face is connected to the sixth angle. The sixth driving face does not intersect with the longitudinal axis. A side of the sixth driving face distant to the sixth end face is located on the front conical face. The first end face is located on a side of the sixth driving face opposite to the sixth end face and does not interest with the sixth. The first side is located on a side of the first end face adjacent to the sixth driving face.

In an example, the end of the driving portion opposite to the shank has a front face. The front face is a circular face orthogonal to the longitudinal axis and centered at the longitudinal axis. The front conical face surrounds the front face.

In an example, each of the first, second, third, fourth, fifth, and sixth end faces is a slant face not perpendicular to the longitudinal axis.

In an example, each two adjacent ones of the first, second, third, fourth, fifth, and sixth peripheral faces have an inner angle of 120° therebetween.

The present invention will become clearer in light of the following detailed description of illustrative embodiments of this invention described in connection with the drawings.

### DESCRIPTION OF THE DRAWINGS

FIG. 1 is a perspective view of an anti-slip fastener driver of a first embodiment according to the present invention.

FIG. 2 is a partial, side elevational view of the anti-slip fastener driver of the first embodiment according to the present invention.

FIG. 3 is an end elevational view of the anti-slip fastener driver of the first embodiment according to the present invention.

FIG. 4 is a perspective view of an anti-slip fastener driver of a second embodiment according to the present invention.

FIG. 5 is a partial, side elevational view of the anti-slip fastener driver of the second embodiment according to the present invention.

FIG. 6 is an end elevational view of the anti-slip fastener driver of the second embodiment according to the present invention.

FIG. 7 is a perspective view of an anti-slip fastener driver of a third embodiment according to the present invention.

FIG. 8 is a partial, side elevational view of the anti-slip fastener driver of the third embodiment according to the present invention.

FIG. 9 is an end elevational view of the anti-slip fastener driver of the third embodiment according to the present invention.

FIG. 10 is a perspective view of an anti-slip fastener driver of a fourth embodiment according to the present invention.

FIG. 11 is a partial, side elevational view of the anti-slip fastener driver of the fourth embodiment according to the present invention.

FIG. 12 is an end elevational view of the anti-slip fastener driver of the fourth embodiment according to the present invention.

FIG. 13 is a perspective view of an anti-slip fastener driver of a fifth embodiment according to the present invention.

FIG. 14 is a partial, side elevational view of the anti-slip fastener driver of the fifth embodiment according to the present invention.

FIG. 15 is an end elevational view of the anti-slip fastener driver of the fifth embodiment according to the present invention.

FIG. 16 is a perspective view of an anti-slip fastener driver of a sixth embodiment according to the present invention.

FIG. 17 is a partial, side elevational view of the anti-slip fastener driver of the sixth embodiment according to the present invention.

FIG. 18 is an end elevational view of the anti-slip fastener driver of the sixth embodiment according to the present invention.

FIG. 19 is a perspective view of an anti-slip fastener driver of a seventh embodiment according to the present invention.

FIG. 20 is a partial, side elevational view of the anti-slip fastener driver of the seventh embodiment according to the present invention.

FIG. 21 is an end elevational view of the anti-slip fastener driver of the seventh embodiment according to the present invention.

FIG. 22 is a perspective view of an anti-slip fastener driver of an eighth embodiment according to the present invention.

FIG. 23 is a partial, side elevational view of the anti-slip fastener driver of the eighth embodiment according to the present invention.

FIG. 24 is an end elevational view of the anti-slip fastener driver of the eighth embodiment according to the present invention.

### DETAILED DESCRIPTION OF THE INVENTION

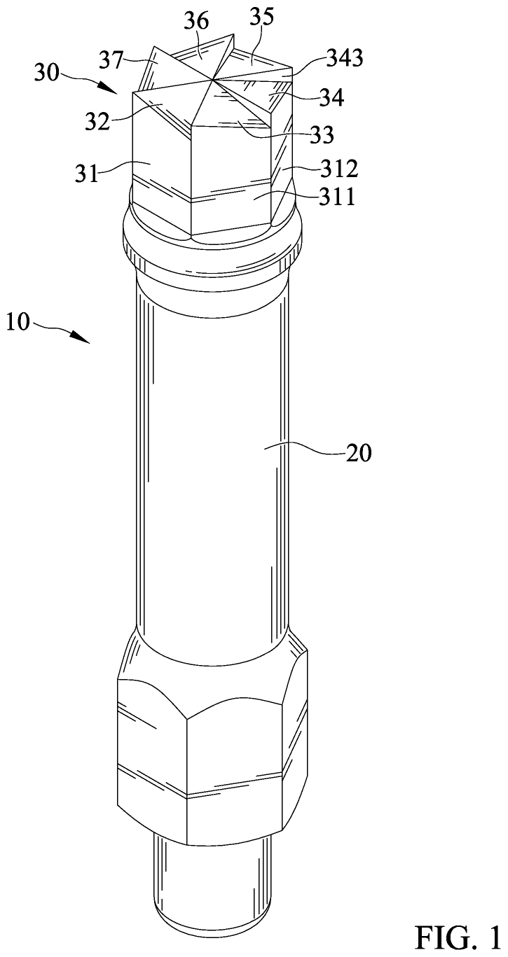

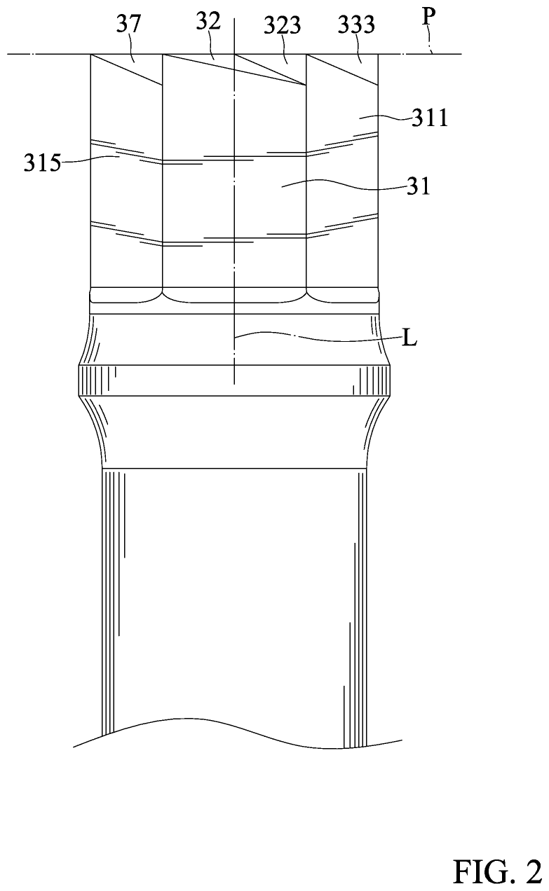

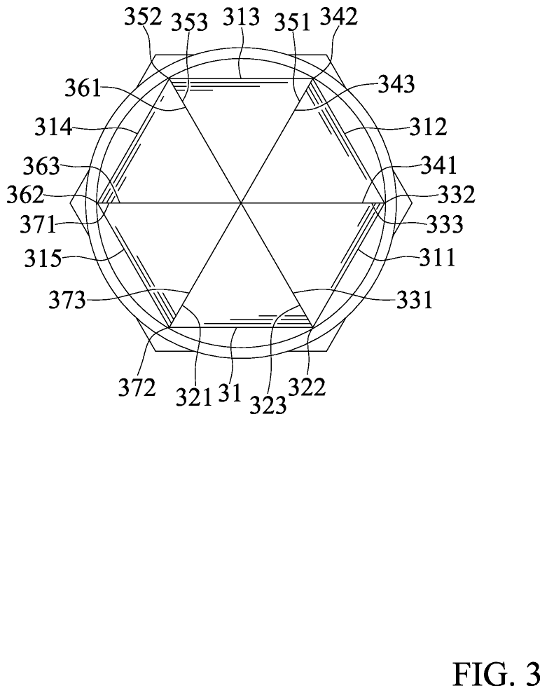

FIGS. 1-3 show a perspective view, a side elevational view, and an end elevational view of an anti-slip fastener driver 10 of a first embodiment according to the present invention. The anti-slip fastener driver 10 includes a shank 20 and a driving portion 30.

The driving portion 30 is formed on an end of the shank 20 and defines a longitudinal axis L. The driving portion 30 includes regular hexagonal cross sections perpendicular to the longitudinal axis L.

The driving portion 30 includes an outer periphery surrounding the longitudinal axis L and having a first peripheral face 31, a second peripheral face 311, a third peripheral face 312, a fourth periphery face 313, a fifth peripheral face 314, and a sixth peripheral face 315. Each of the first, second, third, fourth, fifth, and sixth peripheral faces 31, 311-315 extends in a direction parallel to the longitudinal axis L. Each two adjacent ones of the first, second, third, fourth, fifth, and sixth peripheral faces 31, 311-315 have an inner angle of 120° therebetween.

An end of the driving portion 30 opposite to the shank 20 includes a first end face 32 connected to the first peripheral face 31. The first end face 32 includes a first side 321 and a first angle 322 located outside of the first side 321. The end of the driving portion 30 opposite to the shank 20 includes a reference plane P perpendicular to the longitudinal axis L. The first side 321 is located on the reference plane P. An end of the first side 321 is adjacent to the longitudinal axis L. Another end of the first side 321 opposite to the longitudinal axis L is connected to the first peripheral face 31. The first angle 322 is located between the reference plane P and the shank 20.

The first end face 32 is connected to a first driving face 323 extending in a direction parallel to the longitudinal axis L. The first driving face 323 is connected to the first angle 322. The first driving face 323 includes an angle located on the longitudinal axis L. A side of the first driving face 323 distant to the first end face 32 is located on the reference plane P.

The end of the driving portion 30 opposite to the shank 20 includes a second end face 33 connected to the second peripheral face 311. The second peripheral face 311 is contiguous to the first peripheral face 31. The second end face 33 includes a second side 331 and a second angle 332 located outside of the second side 331. The second side 331 is located on the reference plane P and is connected to the first driving face 323. The end of the first side 321 adjacent to the longitudinal axis L has an end point located on the longitudinal axis L in this embodiment. An end of the second side 331 is connected to the first side 321. An interconnection between the first side 321 and the second side 331 is located on the longitudinal axis L. Another end of the second side 331 opposite to the longitudinal axis L is connected to the second peripheral face 311. The second angle 332 is located between the reference plane P and the shank 20.

The end of the driving portion 30 opposite to the shank 20 includes a third end face 34, a fourth end face 35, a fifth end face 36, and a sixth end face 37. The third end face 34 is connected to the third peripheral face 312. The third peripheral face 312 is contiguous to the second peripheral face 311 and is located on a side of the second peripheral face 311 opposite to the first peripheral face 31. The third end face 34 includes a third side 341 and a third angle 342 located outside of the third side 341. The third side 341 is located on the reference plane P. An end of the third side 341 is connected to the first side 321. An interconnection between the first side 321 and the third side 341 is located on the longitudinal axis L. Another end of the third side 341 opposite to the longitudinal axis L is connected to the third peripheral face 312. The third angle 342 is located between the reference plane P and the shank 20.

The fourth end face 35 is connected to the fourth peripheral face 313. The fourth peripheral face 313 is contiguous to the third peripheral face 312 and is located on a side of the third peripheral face 312 opposite to the second peripheral face 311. The fourth peripheral face 313 is parallel to the first peripheral face 31. The fourth end face 35 includes a fourth side 351 and a fourth angle 352 located outside of the fourth side 351. The fourth side 351 is located on the reference plane P. An end of the fourth side 351 is connected to the first side 321. The first side 321 and the fourth side 351 are located on the same line. An interconnection between the first side 321 and the fourth side 351 is located on the longitudinal axis L. Another end of the fourth side 351 opposite to the longitudinal axis L is connected to the fourth peripheral face 313. The fourth angle 352 is located between the reference plane P and the shank 20.

The fifth end face 36 is connected to the fifth peripheral face 314. The fifth peripheral face 314 is contiguous to the fourth peripheral face 313 and is located on a side of the fourth peripheral face 313 opposite to the third peripheral face 312. The fifth peripheral face 314 is parallel to the second peripheral face 311. The fifth end face 36 includes a fifth side 361 and a fifth angle 362 located outside of the fifth side 361. The fifth side 361 is located on the reference plane P. An end of the fifth side 361 is connected to the second side 331. An intersection between the second side 331 and the fifth side 361 is located on the longitudinal axis L. Another end of the fifth side 361 opposite to the longitudinal axis L is connected to the fifth peripheral face 314. The fifth angle 362 is located between the reference plane P and the shank 20.

The sixth end face 37 is connected to the sixth peripheral face 315. The sixth peripheral face 315 is located between the first peripheral face 31 and the fifth peripheral face 314. The sixth peripheral face 315 is parallel to the third peripheral face 312. The sixth end face 37 includes a sixth side 371 and a sixth angle 372 located outside of the sixth side 371. The sixth side 371 is located on the reference plane P. An end of the sixth side 371 is connected to the third side 341. The third side 341 and the sixth side 371 are on the same line. An interconnection between the third side 341 and the sixth side 371 is located on the longitudinal axis L. Another end of the sixth side 371 opposite to the longitudinal axis L is connected to the sixth peripheral face 315. The sixth angle 372 is located between the reference plane P and the shank 20.

The third end face 34 is connected to a second driving face 343 extending in a direction parallel to the longitudinal axis L. The second driving face 343 is connected to the third angle 342. The second driving face 343 has an angle located on the longitudinal axis L. A side of the second driving face 343 distant to the third end face 34 is located on the reference plane P. The fourth side 351 is connected to the second driving face 343. The fifth end face 36 is connected to a third driving face 363 extending in a direction parallel to the longitudinal axis L. The third driving face 363 is connected to the fifth angle 362. The third driving face 363 has an angle located on the longitudinal axis L. A side of the third driving face 363 distant to the fifth end face 36 is located on the reference plane P. The sixth side 371 is connected to the third driving face 363.

The second end face 33 is connected to a fourth driving face 333 extending in a direction parallel to the longitudinal axis L. The fourth driving face 333 is connected to the second angel 332. The fourth driving face 333 has an angle located on the longitudinal axis L. A side of the fourth driving face 333 distant to the second end face 33 is located on the reference plane P. The third side 341 is connected to the fourth driving face 333. The fourth end face 35 is connected to a fifth driving face 353 extending in a direction parallel to the longitudinal axis L. The fifth driving face 353 is connected to the fourth angle 352. The fifth driving face 353 has an angle located on the longitudinal axis L. A side of the fifth driving face 353 distant to the fourth end face 35 is located on the reference plane P. The fifth side 361 is connected to the fifth driving face 353. The sixth end face 37 is connected to a sixth driving face 373 extending in a direction parallel to the longitudinal axis L. The sixth driving face 373 is connected to the sixth angle 372. The sixth driving face 373 has an angle located on the longitudinal axis L. A side of the sixth driving face 373 distant to the sixth end face 37 is located on the reference plane P. The first side 321 is connected to the sixth driving face 373.

In this embodiment, each of the first, second, third, fourth, fifth, and sixth end faces 32-37 is a slant face at a non-parallel angle to the reference plane P.

The anti-slip fastener driver 10 can achieve an excellent anti-slip effect by the above structure and, thus, can smoothly drive a screw even if the driving hole of the screw is damaged. In use of the anti-slip fastener driver 10, the driving portion 30 can be inserted into the damaged driving hole in a slant direction, and the recess of the first end face 32 forms a corner at the first driving face 323 to contact with an inner wall face of the driving hole, assisting in driving of the screw.

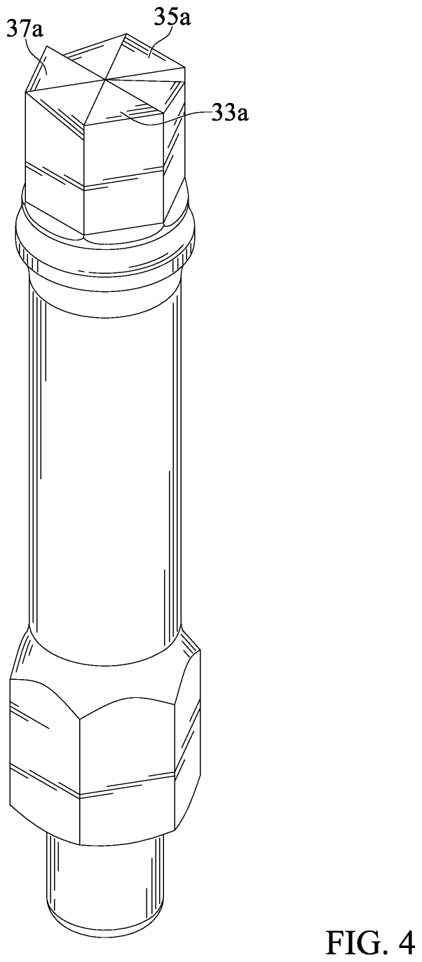

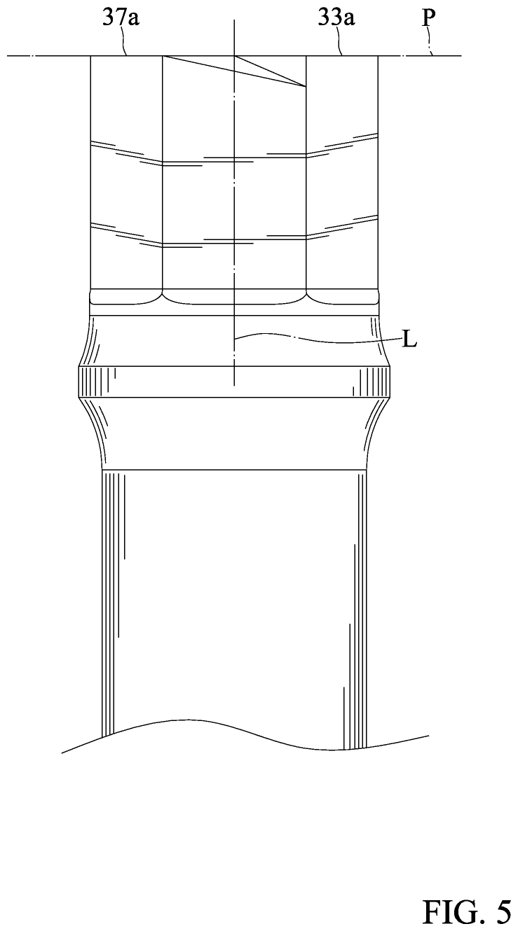

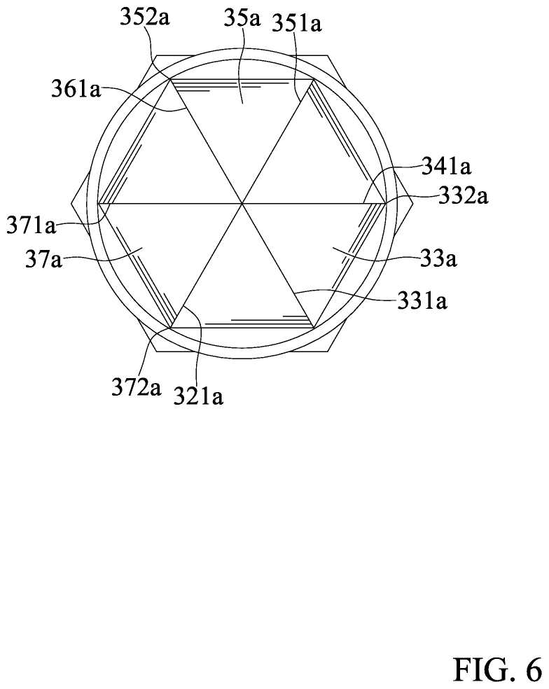

FIGS. 4-6 show a perspective view, a side elevational view, and an end elevational view of an anti-slip fastener driver of a second embodiment according to the present invention. The second embodiment is substantially the same as the first embodiment but is mainly different from the second embodiment by that the second end face 33a is a planar face extending perpendicularly to the longitudinal axis L, the second side 331a and the second angle 332a are located on the reference plane P, the third side 341a is connected to the second end face 33a, the fourth end face 35a is a planar face extending perpendicularly to the longitudinal axis L, the fourth side 351a and the fourth angle 352a are located on the reference plane P, the fifth side 361a is connected to the fourth end face 35a, the sixth end face 37a is a planar face extending perpendicularly to the longitudinal axis L, the sixth side 371a and the sixth angle 372a are located on the reference plane P, and the first side 321a is connected to the sixth end face 37a.

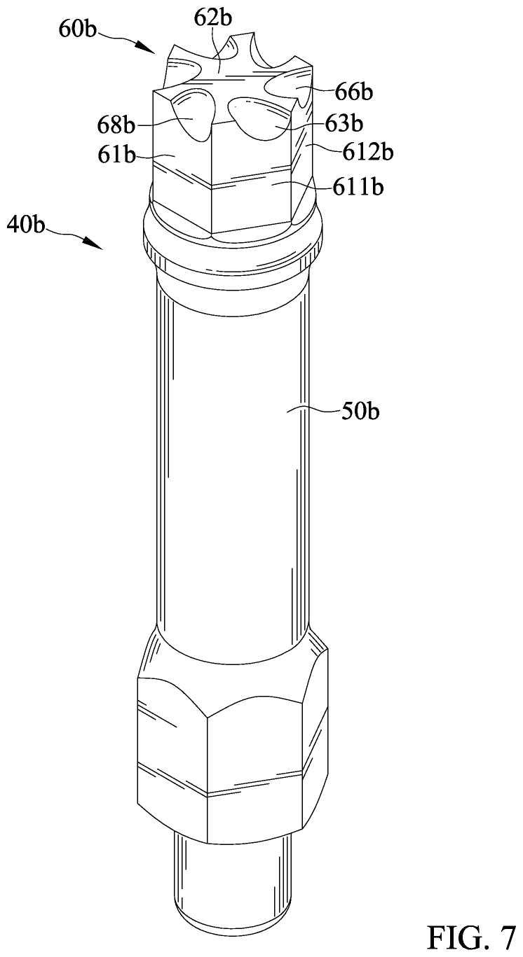

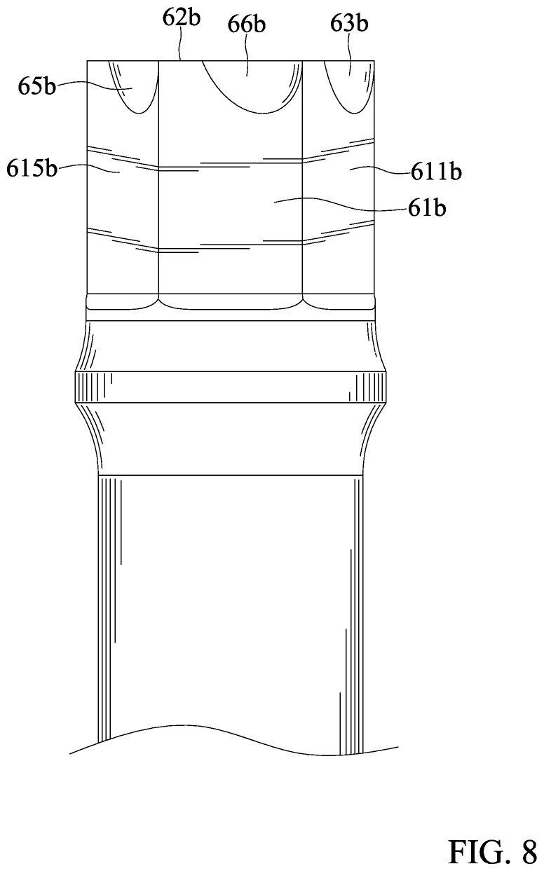

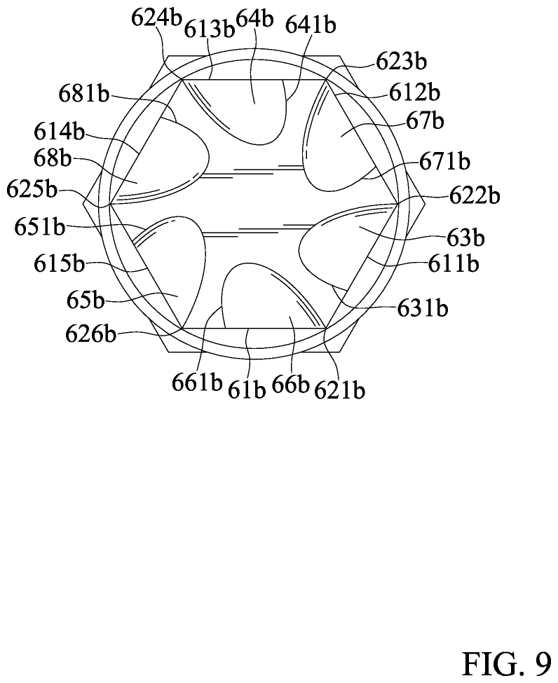

FIGS. 7-9 show a perspective view, a side elevational view, and an end elevational view of an anti-slip fastener driver 40b of a third embodiment according to the present invention. The anti-slip fastener driver 40b includes a shank 50b and a driving portion 60b.

The driving portion 60b is formed on an end of the shank 50b and defines a longitudinal axis L. The driving portion 60b includes regular hexagonal cross sections perpendicular to the longitudinal axis L.

The driving portion 60b includes an outer periphery surrounding the longitudinal axis L and having a first peripheral face 61b, a second peripheral face 611b, a third peripheral face 612b, a fourth peripheral face 613b, a fifth peripheral face 614b, and a sixth peripheral face 615b. Each of the first, second, third, fourth, fifth, and sixth peripheral faces 61b, 611b-615b extends in a direction parallel to the longitudinal axis L. Each two adjacent ones of the first, second, third, fourth, fifth, and sixth peripheral faces 61b, 611b-615b have an inner angle of 120° therebetween.

An end of the driving portion 60b opposite to the shank 50b includes an end face 62b connected to the first, second, and third peripheral faces 61b, 611b, 612b. The second peripheral face 611b is contiguous to the first peripheral face 61b. The third peripheral face 612b is contiguous to the second peripheral face 611b and is located on a side of the second peripheral face 611b opposite to the first peripheral face 61b. The end face 62b includes a first angle 621b and a second angle 622b. The first angle 621b is located on an intersection between the first peripheral face 61b and the second peripheral face 611b. The second angle 622b is located between an intersection between the second peripheral face 611b and the third peripheral face 611b. The driving portion 60b includes a first groove 63b. An end of the first groove 63b is connected to the end face 62b. Another end of the first groove 63b is connected to the second peripheral face 611b. The end of the first groove 63b connected to the end face 62b forms a first edge 631b. An end of the first edge 631b has an end point located on the second angle 622b. The first edge 631 does not intersect with the first angle 621b.

The end face 62b is connected to the first, second, third, fourth, fifth, and sixth peripheral faces 61b, 611b, 612b, 613b, 614b, 615b. The fourth peripheral face 613b is contiguous to the third peripheral face 612b and is located on a side of the third peripheral face 612b opposite to the second peripheral face 611b. The fourth peripheral face 613b is parallel to the first peripheral face 61b. The fifth peripheral face 614b is contiguous to the fourth peripheral face 613b and is located on a side of the fourth peripheral face 613b opposite to the third peripheral face 612b. The fifth peripheral face 614b is parallel to the second peripheral face 611b. The sixth peripheral face 615b is located between the first peripheral face 61b and the fifth peripheral face 614b. The sixth peripheral face 615b is parallel to the third peripheral face 612b.

The end face 62b further includes a third angle 623b, a fourth angle 624b, a fifth angle 625b, and a sixth angle 626b. The third angle 623b is located on an intersection between the third peripheral face 612b and the fourth peripheral face 613b. The fourth angle 624b is located on an intersection between the fourth peripheral face 613b and the fifth peripheral face 614b. The fifth angle 625b is located on an intersection between the third peripheral face 612b and the sixth peripheral face 615b. The sixth angle 626b is located on an intersection between the sixth peripheral face 615b and the first peripheral face 61b.

The driving portion 60b further includes a second groove 64b and a third groove 65b. An end of the second groove 64b is connected to the end face 62b. Another end of the second groove 64b is connected to the fourth peripheral face 613b. The end of the second groove 64b connected to the end face 62b forms a second edge 641b. An end of the second edge 641b is located on the fourth angle 624b. The second edge 641 does not intersect with the third angle 623b. An end of the third groove 65b is connected to the end face 62b. Another end of the third groove 65b is connected to the sixth peripheral face 615b. The end of the third groove 65b connected to the end face 62b forms a third edge 651b. An end of the third edge 651b has an end point located on the sixth angle 626b. The second edge 641b does not intersect with the fifth angle 625b.

The driving portion 60b further includes a fourth groove 66b, a fifth groove 67b, and a sixth groove 68b. An end of the fourth groove 66b is connected to the end face 62b. Another end of the fourth groove 66b is connected to the first peripheral face 61b. The end of the fourth groove 66b connected to the end face 62b forms a fourth edge 661b. An end of the fourth edge 661b has an end point located on the first angle 621b. The fourth edge 661b does not intersect with the sixth angle 626b. An end of the fifth groove 67b is connected to the end face 62b. Another end of the fifth groove 67b is connected to the third peripheral face 612b. The end of the fifth groove 67b connected to the end face 62b forms a fifth edge 671b. An end of the fifth edge 671b is located on the third angle 623b. The fifth edge 671b does not intersect with the second angle 622b. An end of the sixth groove 68b is connected to the end face 62b. Another end of the sixth groove 68b is connected to the fifth peripheral face 614b. The end of the sixth groove 68b connected to the end face 62b forms a sixth edge 681b. An end of the sixth edge 681b has an end point located on the fifth angle 625b. The sixth edge 681b does not intersect with the fourth angle 624b. The first, second, third, fourth, fifth, and sixth edges 631b, 641b, 651b, 661b, 671b, 681b are not connected to each other. Each of the first, second, third, fourth, fifth, and sixth edges 631b, 641b, 651b, 661b, 671b, 681b is arcuate.

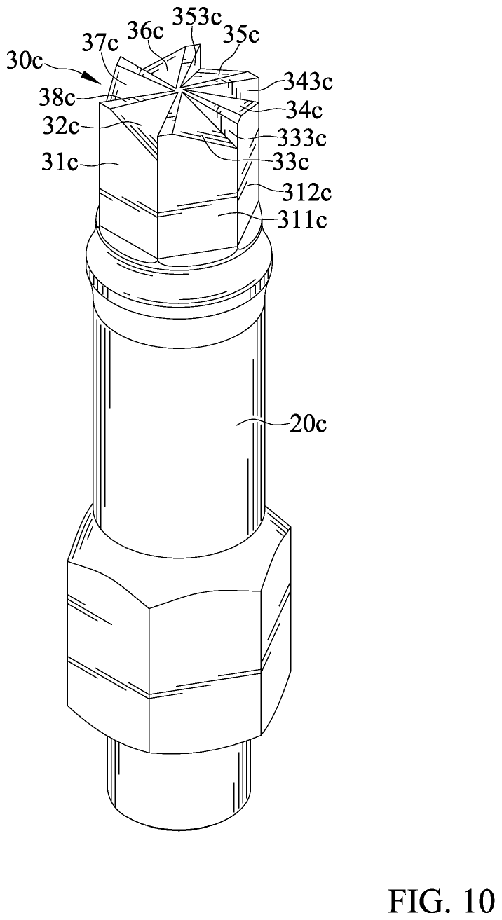

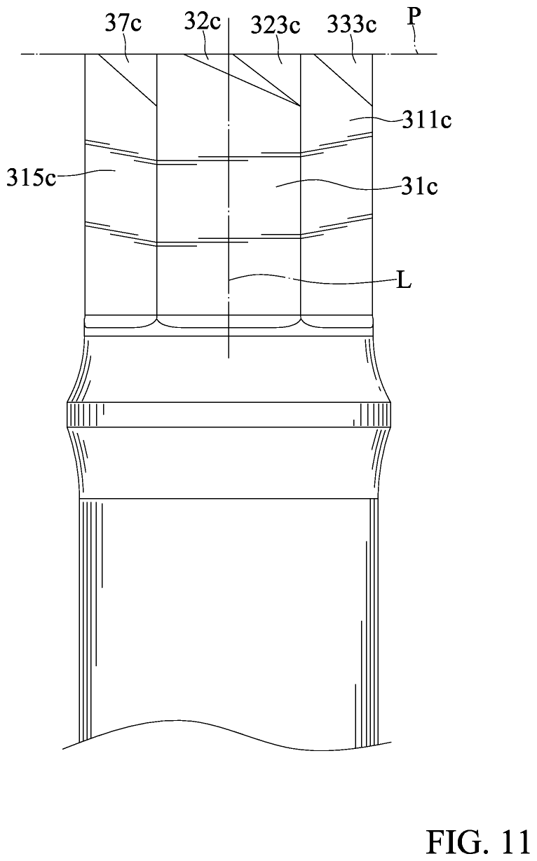

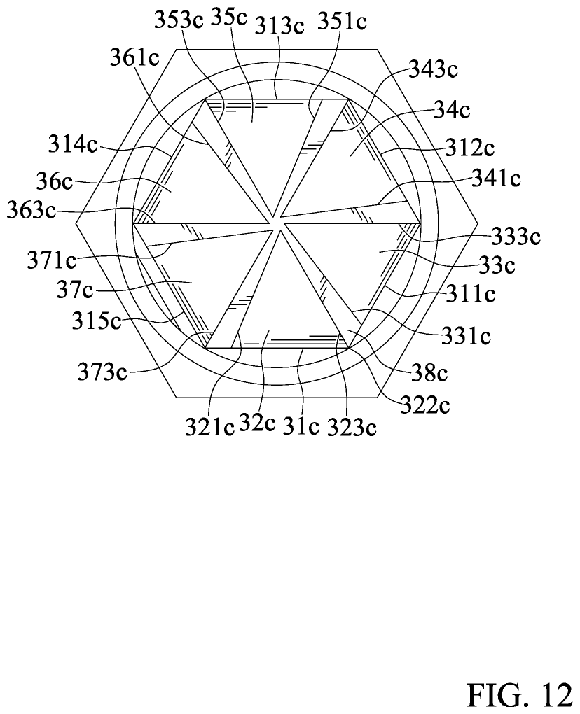

FIGS. 10-12 show a perspective view, a side elevational view, and an end elevational view of an anti-slip fastener driver of a fourth embodiment according to the present invention. The fourth embodiment is substantially the same as the first embodiment but is mainly different from the first embodiment by that an end of the first side 321c adjacent to the longitudinal axis L has an end point not located on the longitudinal axis L, an end of the second side 331c is adjacent to the longitudinal axis L and has an end point not located on the longitudinal axis L, an end of the third side 341c is adjacent to the longitudinal axis L and has an end point not located on the longitudinal axis L, an end of the fourth side 351c is adjacent to the longitudinal axis L and has an end point not located on the longitudinal axis L, an end of the fifth side 361c is adjacent to the longitudinal axis L and has an end point not located on the longitudinal axis L, and an end of the sixth side 371c is adjacent to the longitudinal axis L and has an end point not located on the longitudinal axis L.

The first driving face 323c does not intersect with the longitudinal axis L. The second driving face 343c does not intersect with the longitudinal axis L. The third driving face 363c does not intersect with the longitudinal axis L. The fourth driving face 333c does not intersect with the longitudinal axis L. The fifth driving face 353c does not intersect with the longitudinal axis L. The sixth driving face 373c does not intersect with the longitudinal axis L.

The second end face 33c is located on a side of the first driving face 323c opposite to the first end face 32c and is not connected to the first driving face 323c. The second side 331c is located on a side of the second end face 33c adjacent to the first driving face 323c. The fourth end face 35c is located on a side of the second driving face 343c opposite to the third end face 34c and does not intersect with the second driving face 343c. The fourth side 351c is located on a side of the fourth end face 35c adjacent to the second driving face 343c. The sixth end face 37c is located on a side of the third driving face 363c opposite to the fifth end face 36c and does not intersect with the third driving face 363c. The sixth side 371c is located on a side of the sixth end face 37c adjacent to the third driving face 363c. The third end face 34c is located on a side of the fourth driving face 333c opposite to the first end face 32c and does not intersect with the fourth driving face 333c. The third side 341c is located on a side of the third end face 34c adjacent to the fourth driving face 333c. The fifth end face 36c is located on a side of the fifth driving face 353c opposite to the fourth end face 35c and does not intersect with the fifth driving face 353c. The fifth side 361c is located on a side of the fifth end face 36c adjacent to the fifth driving face 353c. The first end face 32c is located on a side of the sixth driving face 373c opposite to the sixth end face 37c and does not intersect with the sixth driving face 373c. The first side 321 is located on a side of the first end face 32c adjacent to the sixth driving face 373c.

The end of the driving portion 30c opposite to the shank 20c includes a seventh end face 38c. The seventh end face 38c is a planar face extending perpendicularly to the longitudinal axis L and is located on the reference plane P. The seventh end face 38c is connected to the first end face 32c, the first driving face 323c, the second end face 33c, the second driving face 343c, the third end face 34c, the third driving face 363c, the fourth end face 35c, the fourth driving face 333c, the fifth end face 36c, the fifth driving face 353c, the sixth end face 37c, and the sixth driving face 373c. An outer periphery of the seventh end face 38c surrounding the longitudinal axis L is connected to the first peripheral face 31c, the second peripheral face 311c, the third peripheral face 312c, the fourth peripheral face 313c, the fifth peripheral face 314c, and the sixth peripheral face 315c.

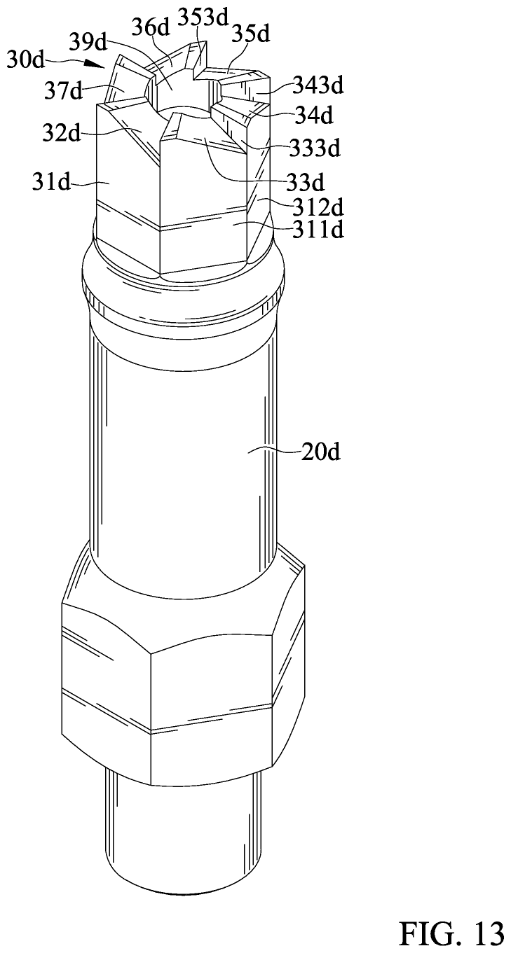

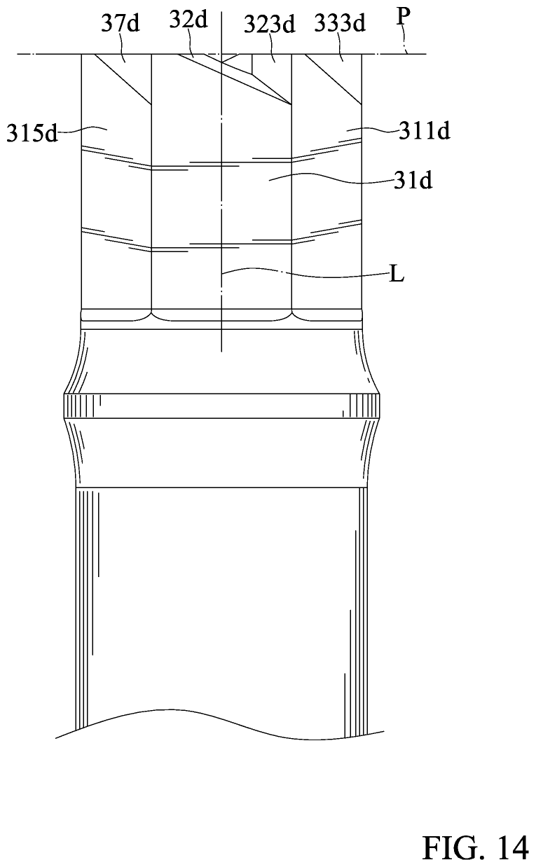

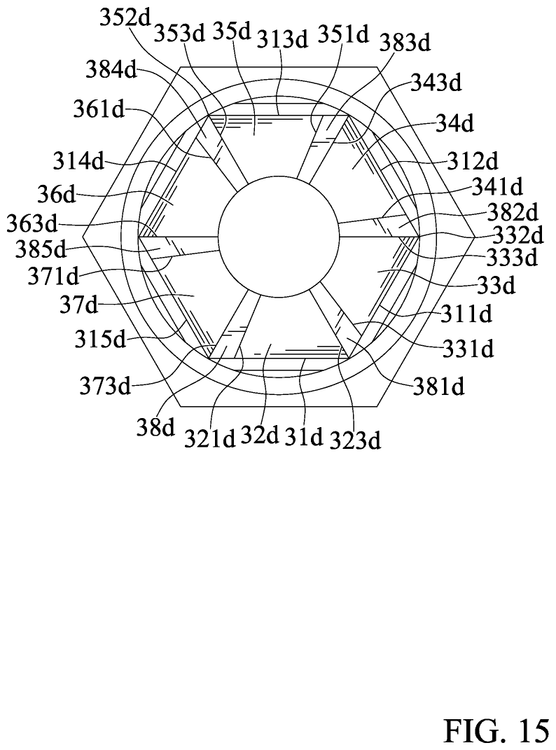

FIGS. 13-15 show a perspective view, a side elevational view, and an end elevational view of an anti-slip fastener driver of a fifth embodiment according to the present invention. The fifth embodiment is substantially the same as the fourth embodiment but is mainly different from fourth embodiment by that the end of the driving portion 30d opposite to the shank 20d includes a hole 39d centered at the longitudinal axis L and extending along the longitudinal axis L, a side of the first end face 32d opposite to the first peripheral face 31d is connected to the hole 39d, and an end of the first side 321d adjacent to the longitudinal axis L and an end of the first driving face 323 adjacent to the longitudinal axis L are connected to the hole 39d.

A side of the second end face 33d opposite to the second peripheral face 311d is connected to the hole 39d. An end of the second side 331d adjacent to the longitudinal axis L and an end of the fourth driving face 333d adjacent to the longitudinal axis L are connected to the hole 39d. A side of the third end face 34d opposite to the third peripheral face 312d is connected to the hole 39d. An end of the third side 341d adjacent to the longitudinal axis L and an end of the second driving face 343d adjacent to the longitudinal axis L are connected to the hole 39d. A side of the fourth end face 35d opposite to the fourth peripheral face 313d is connected to the hole 39d. An end of the fourth side 351d adjacent to the longitudinal axis L and an end of the fifth driving face 353d adjacent to the longitudinal axis L are connected to the hole 39d. A side of the fifth end face 36d opposite to the fifth peripheral face 314d is connected to the hole 39d. An end of the fifth side 361d adjacent to the longitudinal axis L and an end of the third driving face 363d adjacent to the longitudinal axis L are connected to the hole. A side of the sixth end face 37d opposite to the sixth peripheral face 315d is connected to the hole 39d. An end of the sixth side 371d adjacent to the longitudinal axis L and an end of the sixth driving face 393d adjacent to the longitudinal axis L are connected to the hole 39d.

The end of the driving portion 30d opposite to the shank 20d includes a seventh end face 38d, an eighth end face 381d, a ninth end face 382d, a tenth end face 383d, an eleventh end face 384d, and a twelfth end face 385d. Each of the seventh, eighth, ninth, tenth, eleventh, and twelfth end faces 38d, 381d-385d is a planar face extending perpendicularly to the longitudinal axis L and is located on the reference plane P.

The seventh end face 38d is located on a side of the first end face 32d opposite to the first driving face 323d. An end of the seventh end face 38d is connected to the hole 39d. Another end of the seventh end face 38d is connected to the first peripheral face 31d. A side of the seventh end face 38d is connected to the first end face 32d. The first side 321d is formed between the first end face 32d and the seventh end face 38d. The eighth end face 381d is located on a side of the second end face 33d opposite to the fourth driving face 333d. An end of the eighth end face 381d is connected to the hole 39d. Another end of the eighth end face 381d is connected to the second peripheral face 311d. A side of the eighth end face 381d is connected to the second end face 33d. The second side 331d is formed between the second end face 33d and the eighth end face 381d. The ninth end face 382d is located on a side of the third end face 34d opposite to the second driving face 343d. An end of the ninth end face 382d is connected to the hole 39d. Another end of the ninth end face 382d is connected to the third peripheral face 312d. A side of the ninth end face 382d is connected to the third end face 34d. The third side 341d is formed between the third end face 34d and the ninth end face 382d.

The tenth end face 383d is located on a side of the fourth end face 35d opposite to the fifth driving face 353d. An end of the tenth end face 383d is connected to the hole 39d. Another end of the tenth end face 383d is connected to the fourth peripheral face 313d. A side of the tenth end face 383d is connected to the fourth end face 35d. The fourth side 351d is formed between the fourth end face 35d and the tenth end face 383d. The eleventh end face 384d is located on a side of the fifth end face 36d opposite to the third driving face 363d. An end of the eleventh end face 384d is connected to the hole 39d. Another end of the eleventh end face 384d is connected to the fifth peripheral face 314d. A side of the eleventh end face 384d is connected to the fifth end face 36d. The fifth side 361d is formed between the fifth end face 36d and the eleventh end face 384d. The twelfth end face 385d is located on a side of the sixth end face 37d opposite to the sixth driving face 373d. An end of the twelfth end face 386d is connected to the hole 39d. Another end of the twelfth end face 386d is connected to the sixth peripheral face 315d. A side of the twelfth end face 385d is connected to the sixth end face 37d. The sixth side 371d is formed between the sixth end face 37d and the twelfth end face 385d.

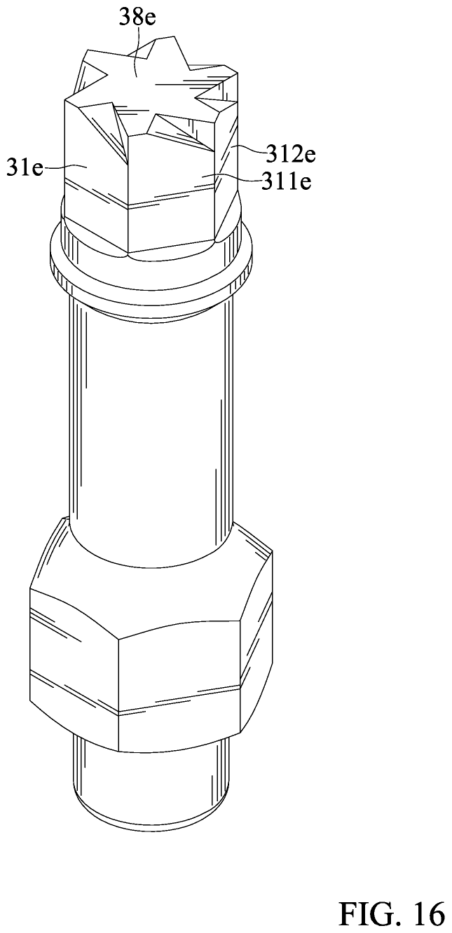

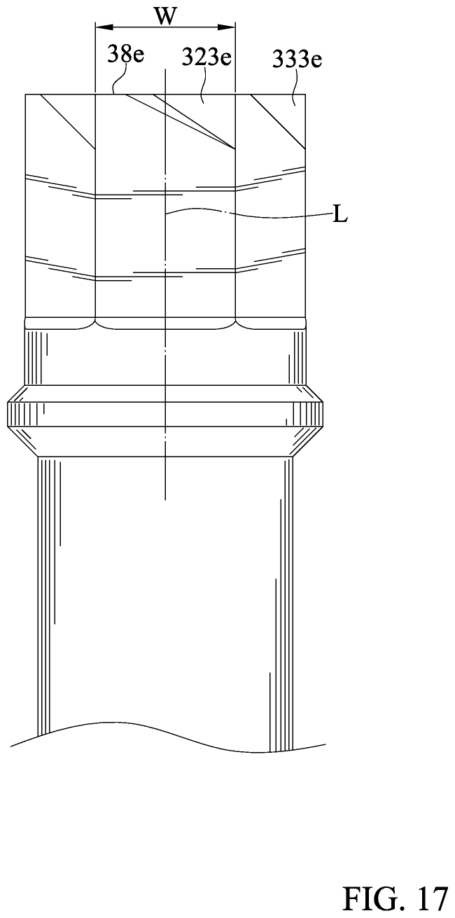

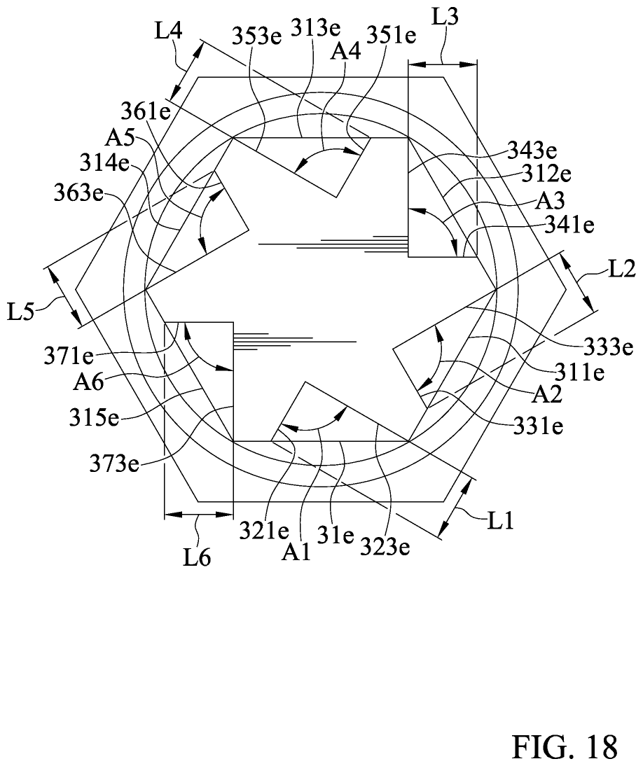

FIGS. 16-18 show a perspective view, a side elevational view, and an end elevational view of an anti-slip fastener driver of a sixth embodiment according to the present invention. The sixth embodiment is substantially the same as the fourth embodiment but is mainly different from the fourth embodiment by that the first peripheral face 31e has a lateral width W in a radial direction perpendicular to the longitudinal axis L, an end of the first side 321e adjacent to the longitudinal axis L and another end of the first side 321e connected to the first peripheral face 31e have a first length L1 therebetween, an end of the second side 331e adjacent to the longitudinal axis L and another end of the second side 331e connected to the second peripheral face 311e have a second length L2 therebetween, an end of the third side 341e adjacent to the longitudinal axis L and another end of the third side 341e connected to the third peripheral face 312e have a third length L3 therebetween, an end of the fourth side 351e adjacent to the longitudinal axis L and another end of the fourth side 351e connected to the fourth peripheral face 313e have a fourth length L4 therebetween, an end of the fifth side 361e adjacent to the longitudinal axis L and another end of the fifth side 361e connected to the fifth peripheral face 314e have a fifth length L5 therebetween, an end of the sixth side 371e adjacent to the longitudinal axis L and another end of the sixth side 371e connected to the sixth peripheral face 315e have a sixth length L6 therebetween, and each of the first length L1, the second length L2, the third length L3, the fourth length L4, the fifth length L5, and the sixth length L6 is smaller than 0.5 times the lateral width W.

Furthermore, the first driving face 323e connected to the seventh end face 38e intersects with the first side 321e. The side of the first driving face 323e and the first side 321e have a first angle A1 therebetween. A side of the fourth driving face 333e connected to the seventh end face 38e intersects with the second side 331e. The side of the fourth driving face 333e and the second side 331e have a second angle A2 therebetween. A side of the second driving face 343e connected to the seventh end face 38e intersects with the third side 341c. The side of the second driving face 343e and the third side 341e have a third angle A3 therebetween. A side of the fifth driving face 353e connected to the seventh end face 38e intersects with the fourth side 351e. The side of the fifth driving face 353e and the fourth side 351e have a fourth angle A4 therebetween. A side of the third driving face 363e connected to the seventh end face 38e intersects with the fifth side 361e. The side of the third driving face 363e and the fifth side 361e have a fifth angle A5 therebetween. A side of the sixth driving face 373e connected to the seventh end face 38e intersects with the sixth side 371e. The side of the sixth driving face 373e and the sixth side 371e have a sixth angle A6 therebetween. Each of the first angle A1, the second angle A2, the third angle A3, the fourth angle A4, the fifth angle A5, and the sixth angle A6 is larger than 80°.

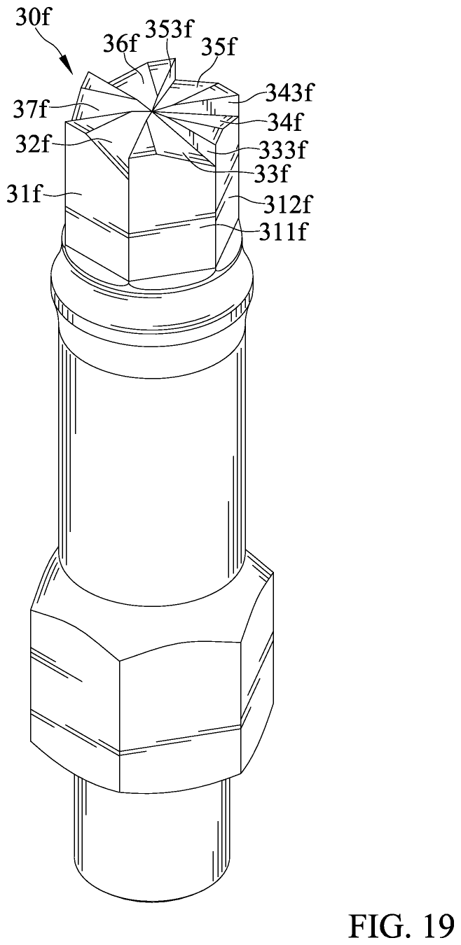

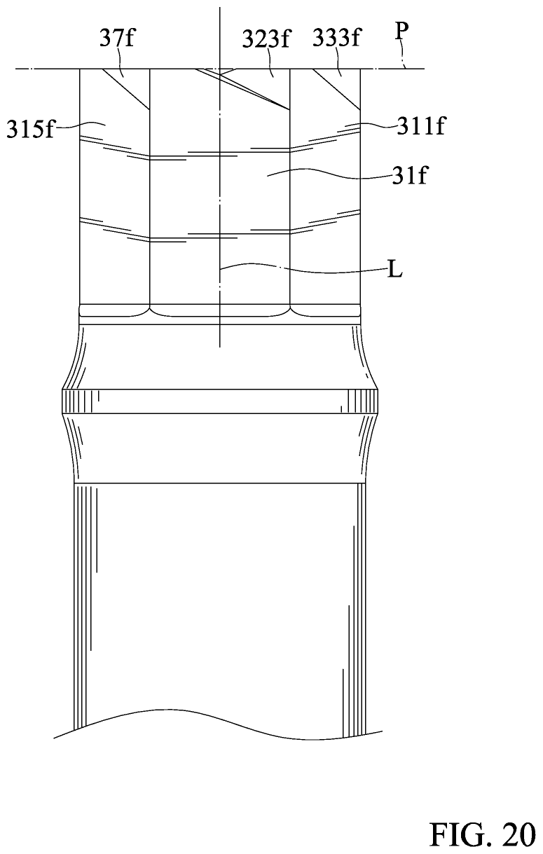

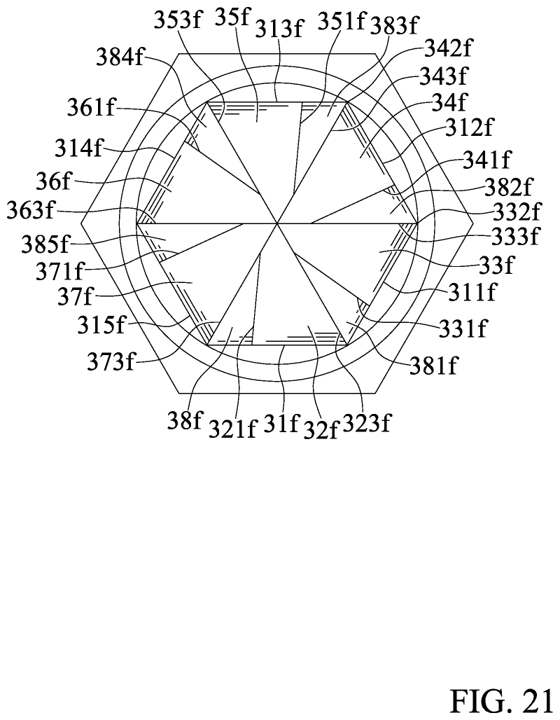

FIGS. 19-21 show a perspective view, a side elevational view, and an end elevational view of an anti-slip fastener driver of a seventh embodiment according to the present invention. The seventh embodiment is substantially the same as the first embodiment but is mainly different from the first embodiment by that an end of the first side 321f adjacent to the longitudinal axis L has an end point not located on the longitudinal axis L, an end of the second side 331f adjacent to the longitudinal axis L has an end point not located on the longitudinal axis L, an end of the third side 341f adjacent to the longitudinal axis L has an end point not located on the longitudinal axis L, an end of the fourth side 351f adjacent to the longitudinal axis L has an end point not located on the longitudinal axis L, an end of the fifth side 361f adjacent to the longitudinal axis L has an end point not located on the longitudinal axis L, and an end of the sixth side 371f adjacent to the longitudinal axis L has an end point not located on the longitudinal axis L.

Furthermore, the end of the first side 321f adjacent to the longitudinal axis L is connected to the sixth driving face 373f. The first driving face 323f does not intersect with the first side 321f. The end of the second side 331f adjacent to the longitudinal axis L is connected to the first driving face 323f. The fourth driving face 333f does not intersect with the second side 331f. The end of the third side 341f adjacent to the longitudinal axis L is connected to the fourth driving face 333f. The second driving face 343f does not intersect with the third side 341f. The end of the fourth side 351f adjacent to the longitudinal axis L is connected to the second driving face 343f. The fifth driving face 353f does not intersect with the fourth side 351f. The end of the fifth side 361f adjacent to the longitudinal axis L is connected to the fifth driving face 353f. The third driving face 363f does not intersect with the fifth side 361f. The end of the sixth side 371f adjacent to the longitudinal axis L is connected to the third driving face 363f The sixth driving face 373f does not intersect with the sixth side 371f.

The end of the driving portion 30f opposite to the shank 20f includes a seventh end face 38f, an eighth end face 381f, a ninth end face 382f, a tenth end face 383f, an eleventh end face 384f, and a twelfth end face 385f. Each of the seventh, eighth, ninth, tenth, eleventh, and twelfth end faces 38f, 381f-385f is a planar face extending perpendicularly to the longitudinal axis L and is located on the reference plane P.

The seventh end face 38f is connected to the first peripheral face 31f, the first end face 32f, and the sixth driving face 373f. The first side 321f is formed between the first end face 32f and the seventh end face 38f. The eighth end face 381f is connected to the second peripheral face 311f, the second end face 33f, and the first driving face 323f. The second side 331f is formed between the second end face 33f and the eighth end face 381f. The ninth end face 382f is connected to the third peripheral face 312f, the third end face 34f, and the fourth driving face 333f. The third side 341d is formed between the third end face 34d and the ninth end face 382f.

The tenth end face 383f is connected to the fourth peripheral face 313f, the fourth end face 35f, and the second driving face 343f. The fourth side 351f is formed between the fourth end face 35f and the tenth end face 383f. The eleventh end face 384f is connected to the fifth peripheral face 314f, the fifth end face 36f, and the fifth driving face 353f. The fifth side 361f is formed between the fifth end face 36f and the eleventh end face 384f. The twelfth end face 385f is connected to the sixth peripheral face 315f, the sixth end face 37f, and the third driving face 363. The sixth side 371f is formed between the sixth end face 37f and the twelfth end face 385f.

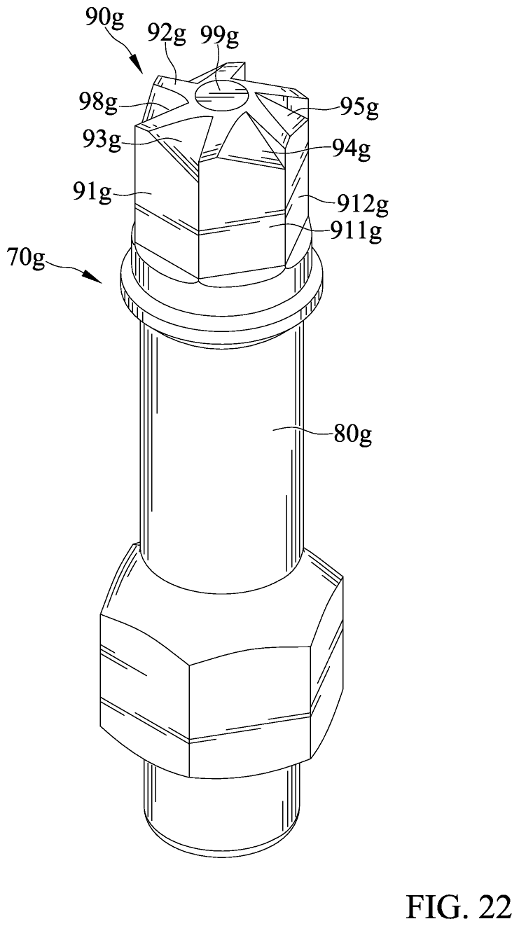

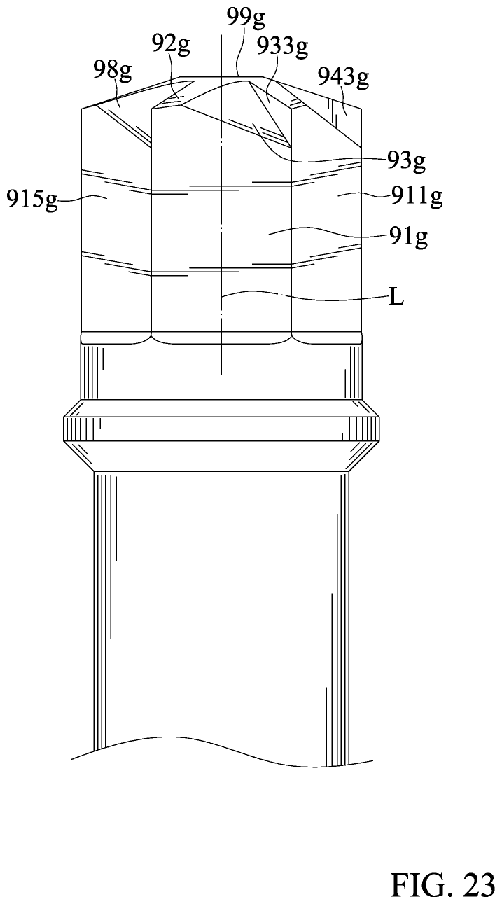

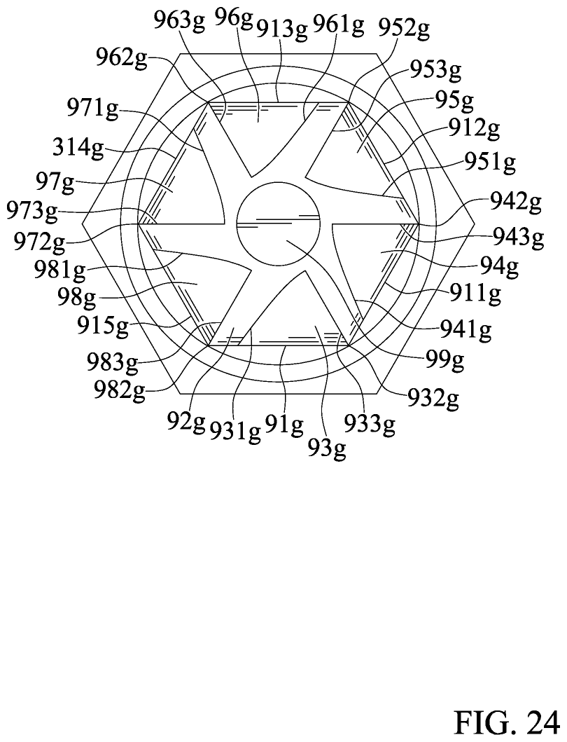

FIGS. 22-24 show a perspective view, a side elevational view, and an end elevational view of an anti-slip fastener driver 70g of an eighth embodiment according to the present invention. The anti-slip fastener driver 70g includes a shank 80g and a driving portion 90g.

The driving portion 90g is formed on an end of the shank 80g and defines a longitudinal axis L. The driving portion 90g includes regular hexagonal cross sections perpendicular to the longitudinal axis L.

The driving portion 90g includes an outer periphery surrounding the longitudinal axis L and having a first peripheral face 91g, a second peripheral face 911g, a third peripheral face 912g, a fourth periphery face 913g, a fifth peripheral face 914g, and a sixth peripheral face 915g. Each of the first, second, third, fourth, fifth, and sixth peripheral faces 91g, 911g-915g extends in a direction parallel to the longitudinal axis L. Each two adjacent ones of the first, second, third, fourth, fifth, and sixth peripheral faces 91g, 911g-915g have an inner angle of 120° therebetween.

An end of the driving portion 90g opposite to the shank 80g includes a front conical face 92g and a first end face 93g. The front conical face 92g is a conical face centered at the longitudinal axis L. The first end face 93g is connected to the first peripheral face 91g. The first end face 93g includes a first side 931g and a first angle 932g not located on the first side 931g. The first side 931g is located on the front conical face 92g. An end of the first side 931g is adjacent to the longitudinal axis L. Another end of the first side 931g opposite to the longitudinal axis L is connected to the first peripheral face 91g. The first angle 932g is located between the front conical face 92g and the shank 80g along the longitudinal axis L.

An end of the first side 931g adjacent to the longitudinal axis L has an end point not located on the longitudinal axis L. The first end face 93g is connected to a first driving face 933g extending in a direction parallel to the longitudinal axis L. The first driving face 933g is connected to the first angle 932g. The first driving face 933g does not intersect with the longitudinal axis L. A side of the first driving face 933g distant to the first end face 93g is located on the front conical face 92g.

The end of the driving portion 90g opposite to the shank 80g includes a second end face 94g connected to the second peripheral face 911g. The second peripheral face 911g is contiguous to the first peripheral face 91g. The second end face 94g includes a second side 941g and a second angle 942g located outside of the second side 941g. The second side 941g is located on the front conical face 92g. An end of the second side 941g is adjacent to the longitudinal axis L and has an end point not located on the longitudinal axis L. Another end of the second side 941g opposite to the longitudinal axis L is connected to the second peripheral face 911g. The second angle 942g is located between the front conical face 92g and the shank 80g along the longitudinal axis L.

The end of the driving portion 90g opposite to the shank 80g includes a third end face 95g, a fourth end face 96g, a fifth end face 97g, and a sixth end face 98g. The third end face 95g is connected to the third peripheral face 912g. The third peripheral face 912g is contiguous to the second peripheral face 911g and is located on a side of the second peripheral face 911g opposite to the first peripheral face 91g. The third end face 95g includes a third side 951g and a third angle 952g located outside of the third side 951g. The third side 951g is located on the front conical face 92g. An end of the third side 951g is adjacent to the longitudinal axis L and has an end point not located on the longitudinal axis L. Another end of the third side 951g opposite to the longitudinal axis L is connected to the third peripheral face 912g. The third angle 952g is located between the front conical face 92g and the shank 80g along the longitudinal axis L.

The fourth end face 96g is connected to the fourth peripheral face 913g. The fourth peripheral face 913g is contiguous to the third peripheral face 912g and is located on a side of the third peripheral face 912g opposite to the second peripheral face 911g. The fourth peripheral face 913g is parallel to the first peripheral face 91g. The fourth end face 96g includes a fourth side 961g and a fourth angle 962g located outside of the fourth side 961g. The fourth side 961g is located on the front conical face 92g. An end of the fourth side 961g is adjacent to the longitudinal axis L and has an end point not located on the longitudinal axis L. Another end of the fourth side 961g opposite to the longitudinal axis L is connected to the fourth peripheral face 913g. The fourth angle 962g is located between the front conical face 92g and the shank 80g along the longitudinal axis L.

The fifth end face 97g is connected to the fifth peripheral face 914g. The fifth peripheral face 914g is contiguous to the fourth peripheral face 913g and is located on a side of the fourth peripheral face 913g opposite to the third peripheral face 912g. The fifth peripheral face 914g is parallel to the second peripheral face 911g. The fifth end face 97g includes a fifth side 971g and a fifth angle 972g located outside of the fifth side 971g. The fifth side 971g is located on the front conical face 92g. An end of the fifth side 971g is adjacent to the longitudinal axis L and has an end point not located on the longitudinal axis L. Another end of the fifth side 971g opposite to the longitudinal axis L is connected to the fifth peripheral face 914g. The fifth angle 972g is located between the front conical face 92g and the shank 80g along the longitudinal axis L.

The sixth end face 98g is connected to the sixth peripheral face 915g. The sixth peripheral face 915g is located between the first peripheral face 91g and the fifth peripheral face 914g. The sixth peripheral face 915g is parallel to the third peripheral face 912g. The sixth end face 98g includes a sixth side 981g and a sixth angle 982g located outside of the sixth side 981g. The sixth side 981g is located on the front conical face 92g. An end of the sixth side 981g is adjacent to the longitudinal axis L and has an end point not located on the longitudinal axis L. Another end of the sixth side 981g opposite to the longitudinal axis L is connected to the sixth peripheral face 915g. The sixth angle 982g is located between the front conical face 92g and the shank 80g along the longitudinal axis L.

The third end face 95g is connected to a second driving face 953g extending in a direction parallel to the longitudinal axis L. The second driving face 953g is connected to the third angle 952g. The second driving face 953g does not intersect with the longitudinal axis L. A side of the second driving face 953g distant to the third end face 95g is located on the front conical face 92g. The fifth end face 97g is connected to a third driving face 973g extending in a direction parallel to the longitudinal axis L. The third driving face 973g is connected to the fifth angle 972g. The third driving face 973g does not intersect with the longitudinal axis L. A side of the third driving face 973g distant to the fifth end face 97g is located on the front conical face 92g.

The second end face 94g is connected to a fourth driving face 943g extending in a direction parallel to the longitudinal axis L. The fourth driving face 943g is connected to the second angle 942g. The fourth driving face 943g does not intersect with the longitudinal axis L. A side of the fourth driving face 943g distant to the second end face 94g is located on the front conical face 92g. The fourth end face 96g is connected to a fifth driving face 963g extending in a direction parallel to the longitudinal axis L. The fifth driving face 963g is connected to the fourth angle 962g. The fifth driving face 963g does not intersect with the longitudinal axis L. A side of the fifth driving face 963g distant to the fourth end face 96g is located on the front conical face 92g. The sixth end face 98g is connected to a sixth driving face 983g extending in a direction parallel to the longitudinal axis L. The sixth driving face 983g is connected to the sixth angle 982g. The sixth driving face 983g does not intersect with the longitudinal axis L. A side of the sixth driving face 983g distant to the sixth end face 98g is located on the front conical face 92g.

The second end face 94g is located on a side of the first driving face 933g opposite to the first end face 93g and does not intersect with the first driving face 933g. The second side 941g is located on a side of the second end face 94g adjacent to the first driving face 933g. The fourth end face 96g is located on a side of the second driving face 953g opposite to the third end face 95g and does not intersect with the second driving face 953g. The fourth side 961g is located on a side of the fourth end face 96g adjacent to the second driving face 953g. The sixth end face 98g is located on a side of the third driving face 973g opposite to the fifth end face 97g and does not intersect with the third driving face 973g. The sixth side 981g is located on a side of the sixth end face 98g adjacent to the third driving face 973g.

The third end face 95g is located on a side of the fourth driving face 943g opposite to the first end face 93g and does not intersect with the fourth driving face 943g. The third side 951g is located on a side of the third end face 95g adjacent to the fourth driving face 943g. The fifth end face 97g is located on a side of the fifth driving face 963g opposite to the fourth end face 96g and does not intersect with the fifth driving face 963g. The fifth side 971g is located on a side of the fifth end face 97g adjacent to the fifth driving face 963g. The first end face 93g is located on a side of the sixth driving face 983g opposite to the sixth end face 98g and does not intersect with the sixth driving face 983g. The first side 931g is located on a side of the first end face 93g adjacent to the sixth driving face 983g.

Each of the first, second, third, fourth, fifth, and sixth end faces 93g-98g is a slant face not perpendicular to the longitudinal axis.

The end of the driving portion 90g opposite to the shank 80g has a front face 99g. The front face 99g is a circular face orthogonal to the longitudinal axis L and centered at the longitudinal axis L. The front conical face 92g surrounds the front face 99g.

In view of the above description, the present invention includes the following advantages:

1. An anti-slip fastener driver 10 comprises a shank 20 and a driving portion 30. The driving portion 30 is formed on an end of the shank 20 and defines a longitudinal axis L. The driving portion 30 includes an outer periphery surrounding the longitudinal axis L and having a first peripheral face 31. An end of the driving portion 30 opposite to the shank 20 includes a first end face 32 connected to the first peripheral face 31. The first end face 32 includes a first side 321 and a first angle 322 located outside of the first side 321. The end of the driving portion 30 opposite to the shank 20 includes a reference plane P perpendicular to the longitudinal axis L. The first side 321 is located on the reference plane P. An end of the first side 321 is adjacent to the longitudinal axis L. Another end of the first side 321 opposite to the longitudinal axis L is connected to the first peripheral face 31. The first angle 322 is located between the reference plane P and the shank 20. The anti-slip fastener driver 10 provides an excellent anti-slip effect by the above structure.

2. An anti-slip fastener driver 40b comprises a shank 50b and a driving portion 60b. The driving portion 60b is formed on an end of the shank 50b and defines a longitudinal axis L. The driving portion 60b includes an outer periphery surrounding the longitudinal axis L and having a first peripheral face 61b, a second peripheral face 611b, and a third peripheral face 612b. An end of the driving portion 60b opposite to the shank 50b includes an end face 62b connected to the first, second, and third peripheral faces 61b, 611b, 612b. The second peripheral face 611b is contiguous to the first peripheral face 61b. The third peripheral face 612b is contiguous to the second peripheral face 611b and is located on a side of the second peripheral face 611b opposite to the first peripheral face 61b. The end face 62b includes a first angle 621b and a second angle 622b. The first angle 621b is located on an intersection between the first peripheral face 61b and the second peripheral face 611b. The second angle 622b is located between an intersection between the second peripheral face 611b and the third peripheral face 611b. The driving portion 60b includes a first groove 63b. An end of the first groove 63b is connected to the end face 62b. Another end of the first groove 63b is connected to the second peripheral face 611b. The end of the first groove 63b connected to the end face 62b forms a first edge 631b. An end of the first edge 631b has an end point located on the second angle 622b. The first edge 631 does not intersect with the first angle 621b. The anti-slip fastener driver 40b provides an excellent anti-slip effect by the above structure.

3. An anti-slip fastener driver 70g comprises a shank 80g and a driving portion 90g. The driving portion 90g is formed on an end of the shank 80g and defines a longitudinal axis L. The driving portion 90g includes an outer periphery surrounding the longitudinal axis L and having a first peripheral face 91g. An end of the driving portion 90g opposite to the shank 80g includes a front conical face 92g and a first end face 93g. The front conical face 92g is a conical face centered at the longitudinal axis L. The first end face 93g is connected to the first peripheral face 91g. The first end face 93g includes a first side 931g and a first angle 932g not located on the first side 931g. The first side 931g is located on the front conical face 92g. An end of the first side 931g is adjacent to the longitudinal axis L. Another end of the first side 931g opposite to the longitudinal axis L is connected to the first peripheral face 91g. The first angle 932g is located between the front conical face 92g and the shank 80g along the longitudinal axis L. The anti-slip fastener driver 70g provides an excellent anti-slip effect by the above structure.

Although specific embodiments have been illustrated and described, numerous modifications and variations are still possible without departing from the scope of the invention. The scope of the invention is limited by the accompanying claims.

1. An anti-slip fastener driver comprising:
a shank;
a driving portion formed on an end of the shank and defining a longitudinal axis, wherein the driving portion includes an outer periphery surrounding the longitudinal axis and having a first peripheral face, wherein an end of the driving portion opposite to the shank includes a first end face connected to the first peripheral face, wherein the first end face includes a first side and a first angle located outside of the first side, wherein the end of the driving portion opposite to the shank includes a reference plane perpendicular to the longitudinal axis, wherein the first side is located on the reference plane, wherein an end of the first side is adjacent to the longitudinal axis, wherein another end of the first side opposite to the longitudinal axis is connected to the first peripheral face, and wherein the first angle is located between the reference plane and the shank.

2. The anti-slip fastener driver as claimed in claim 1, wherein the first peripheral face extends in a direction parallel to the longitudinal axis, wherein the first end face is connected to a first driving face extending in a direction parallel to the longitudinal axis, wherein the first driving face is connected to the first angle, wherein the first driving face includes an angle located on the longitudinal axis, and wherein a side of the first driving face distant to the first end face is located on the reference plane.

3. The anti-slip fastener driver as claimed in claim 2, wherein the outer periphery of the driving portion surrounding the longitudinal axis further includes a second peripheral face extending in a direction parallel to the longitudinal axis, wherein the end of the driving portion opposite to the shank includes a second end face connected to the second peripheral face, wherein the second peripheral face is contiguous to the first peripheral face, wherein the second end face includes a second side and a second angle located outside of the second side, wherein the second side is located on the reference plane and is connected to the first driving face, wherein the end of the first side adjacent to the longitudinal axis has an end point located on the longitudinal axis, wherein an end of the second side is connected to the first side, wherein an interconnection between the first side and the second side is located on the longitudinal axis, wherein another end of the second side opposite to the longitudinal axis is connected to the second peripheral face, and wherein the second angle is located between the reference plane and the shank.

4. The anti-slip fastener driver as claimed in claim 3, wherein the outer periphery of the driving portion surrounding the longitudinal axis further includes a third peripheral face, a fourth periphery face, a fifth peripheral face, and a sixth peripheral face, wherein each of the third, fourth, fifth, and sixth peripheral faces extends in a direction parallel to the longitudinal axis,
wherein the end of the driving portion opposite to the shank includes a third end face, a fourth end face, a fifth end face, and a sixth end face, wherein the third end face is connected to the third peripheral face, wherein the third peripheral face is contiguous to the second peripheral face and is located on a side of the second peripheral face opposite to the first peripheral face, wherein the third end face includes a third side and a third angle located outside of the third side, wherein the third side is located on the reference plane, wherein an end of the third side is connected to the first side, wherein an interconnection between the first side and the third side is located on the longitudinal axis, wherein another end of the third side opposite to the longitudinal axis is connected to the third peripheral face, wherein the third angle is located between the reference plane and the shank,
wherein the fourth end face is connected to the fourth peripheral face, wherein the fourth peripheral face is contiguous to the third peripheral face and is located on a side of the third peripheral face opposite to the second peripheral face, wherein the fourth peripheral face is parallel to the first peripheral face, wherein the fourth end face includes a fourth side and a fourth angle located outside of the fourth side, wherein the fourth side is located on the reference plane, wherein an end of the fourth side is connected to the first side, wherein the first side and the fourth side are located on a same line, wherein an interconnection between the first side and the fourth side is located on the longitudinal axis, wherein another end of the fourth side opposite to the longitudinal axis is connected to the fourth peripheral face, wherein the fourth angle is located between the reference plane and the shank,
wherein the fifth end face is connected to the fifth peripheral face, wherein the fifth peripheral face is contiguous to the fourth peripheral face and is located on a side of the fourth peripheral face opposite to the third peripheral face, wherein the fifth peripheral face is parallel to the second peripheral face, wherein the fifth end face includes a fifth side and a fifth angle located outside of the fifth side, wherein the fifth side is located on the reference plane, wherein an end of the fifth side is connected to the second side, wherein an intersection between the second side and the fifth side is located on the longitudinal axis, wherein another end of the fifth side opposite to the longitudinal axis is connected to the fifth peripheral face, wherein the fifth angle is located between the reference plane and the shank,
wherein the sixth end face is connected to the sixth peripheral face, wherein the sixth peripheral face is located between the first peripheral face and the fifth peripheral face, wherein the sixth peripheral face is parallel to the third peripheral face, wherein the sixth end face includes a sixth side and a sixth angle located outside of the sixth side, wherein the sixth side is located on the reference plane, wherein an end of the sixth side is connected to the third side, wherein the third side and the sixth side are on a same line, wherein an interconnection between the third side and the sixth side is located on the longitudinal axis, wherein another end of the sixth side opposite to the longitudinal axis is connected to the sixth peripheral face, wherein the sixth angle is located between the reference plane and the shank,
wherein the third end face is connected to a second driving face extending in a direction parallel to the longitudinal axis, wherein the second driving face is connected to the third angle, wherein the second driving face has an angle located on the longitudinal axis, wherein a side of the second driving face distant to the third end face is located on the reference plane, wherein the fourth side is connected to the second driving face, wherein the fifth end face is connected to a third driving face extending in a direction parallel to the longitudinal axis, wherein the third driving face is connected to the fifth angle, wherein the third driving face has an angle located on the longitudinal axis, wherein a side of the third driving face distant to the fifth end face is located on the reference plane, wherein the sixth side is connected to the third driving face,
wherein the second end face is connected to a fourth driving face extending in a direction parallel to the longitudinal axis, wherein the fourth driving face is connected to the second angel, wherein the fourth driving face has an angle located on the longitudinal axis, wherein a side of the fourth driving face distant to the second end face is located on the reference plane, wherein the third side is connected to the fourth driving face, wherein the fourth end face is connected to a fifth driving face extending in a direction parallel to the longitudinal axis, wherein the fifth driving face is connected to the fourth angle, wherein the fifth driving face has an angle located on the longitudinal axis, wherein a side of the fifth driving face distant to the fourth end face is located on the reference plane, wherein the fifth side is connected to the fifth driving face, wherein the sixth end face is connected to a sixth driving face extending in a direction parallel to the longitudinal axis, wherein the sixth driving face is connected to the sixth angle, wherein the sixth driving face has an angle located on the longitudinal axis, wherein a side of the sixth driving face distant to the sixth end face is located on the reference plane, and wherein the first side is connected to the sixth driving face.

5. The anti-slip fastener driver as claimed in claim 4, wherein each of the first, second, third, fourth, fifth, and sixth end faces is a slant face at a non-parallel angle to the reference plane.

6. The anti-slip fastener driver as claimed in claim 2, wherein the outer periphery of the driving portion surrounding the longitudinal axis further includes a second peripheral face extending in a direction parallel to the longitudinal axis, wherein the end of the driving portion opposite to the shank includes a second end face connected to the second peripheral face, wherein the second peripheral face is contiguous to the first peripheral face, wherein the second end face includes a second side and a second angle located outside of the second side, wherein the second end face is a planar face extending perpendicularly to the reference plane, wherein the second side and the second angel are located on the reference plane, wherein the end of the first side adjacent to the longitudinal axis has an end point located on the longitudinal axis, wherein an end of the second side is connected to the first side, wherein an interconnection between the first side and the second side is located on the longitudinal axis, wherein another end of the second side opposite to the longitudinal axis is connected to the second peripheral face.

7. The anti-slip fastener driver as claimed in claim 6, wherein the outer periphery of the driving portion surrounding the longitudinal axis further includes a third peripheral face, a fourth peripheral face, a fifth peripheral face, and a sixth peripheral face, wherein each of the third, fourth, fifth, and sixth peripheral faces extends in a direction parallel to the longitudinal axis,
wherein the end of the driving portion opposite to the shank includes a third end face, a fourth end face, a fifth end face, and a sixth end face, wherein the third end face is connected to the third peripheral face, wherein the third peripheral face is contiguous to the second peripheral face and is located on a side of the second peripheral face opposite to the first peripheral face, wherein the third end face includes a third side and a third angle located outside of the third side, wherein the third side is located on the reference plane, wherein the third side is connected to the second end face, wherein an end of the third side is connected to the first side, wherein an interconnection between the first side and the third side is located on the longitudinal axis, wherein another end of the third side opposite to the longitudinal axis is connected to the third peripheral face, wherein the third angle is located between the reference plane and the shank,
wherein the fourth end face is connected to the fourth peripheral face, wherein the fourth peripheral face is contiguous to the third peripheral face and is located on a side of the third peripheral face opposite to the second peripheral face, wherein the fourth peripheral face is parallel to the first peripheral face, wherein the fourth end face includes a fourth side and a fourth angle located outside of the fourth side, wherein the fourth peripheral face is a planar face extending perpendicularly to the longitudinal axis, wherein the fourth side and fourth angle are located on the reference plane, wherein an end of the fourth side is connected to the first side, wherein the first side and the fourth side are located on a same line, wherein an interconnection between the first side and the fourth side is located on the longitudinal axis, wherein another end of the fourth side opposite to the longitudinal axis is connected to the fourth peripheral face, wherein the fourth angle is located between the reference plane and the shank,
wherein the fifth end face is connected to the fifth peripheral face, wherein the fifth peripheral face is contiguous to the fourth peripheral face and is located on a side of the fourth peripheral face opposite to the third peripheral face, wherein the fifth peripheral face is parallel to the second peripheral face, wherein the fifth end face includes a fifth side and a fifth angle located outside of the fifth side, wherein the fifth side is located on the reference plane, wherein the fifth side is connected to the fourth end face, wherein an end of the fifth side is connected to the second side, wherein an intersection between the second side and the fifth side is located on the longitudinal axis, wherein another end of the fifth side opposite to the longitudinal axis is connected to the fifth peripheral face, wherein the fifth angle is located between the reference plane and the shank,
wherein the sixth end face is connected to the sixth peripheral face, wherein the sixth peripheral face is located between the first peripheral face and the fifth peripheral face, wherein the sixth peripheral face is parallel to the third peripheral face, wherein the first side is connected to the sixth end face, wherein the sixth end face includes a sixth side and a sixth angle located outside of the sixth side, wherein the sixth end face is a planar face extending perpendicularly to the longitudinal axis, wherein the sixth side and the sixth angle are located on the reference plane, wherein an end of the sixth side is connected to the third side, wherein the third side and the sixth side are on a same line, wherein an interconnection between the third side and the sixth side is located on the longitudinal axis, wherein another end of the sixth side opposite to the longitudinal axis is connected to the sixth peripheral face, wherein the sixth angle is located between the reference plane and the shank,
wherein the third end face is connected to a second driving face extending in a direction parallel to the longitudinal axis, wherein the second driving face is connected to the third angle, wherein the second driving face has an angle located on the longitudinal axis, wherein a side of the second driving face distant to the third end face is located on the reference plane, wherein the fourth side is connected to the second driving face, wherein the fifth end face is connected to a third driving face extending in a direction parallel to the longitudinal axis, wherein the third driving face is connected to the fifth angle, wherein the third driving face has an angle located on the longitudinal axis, wherein a side of the third driving face distant to the fifth end face is located on the reference plane, and wherein the sixth side is connected to the third driving face.

8. The anti-slip fastener driver as claimed in claim 7, wherein each of the first end face, the third end face, and the fifth end face is a slant face at a non-parallel angle to the reference plane.

9. The anti-slip fastener driver as claimed in claim 1, wherein the end of the first side adjacent to the longitudinal axis has an end point not located on the longitudinal axis, wherein the first end face is connected to a first driving face extending in a direction parallel to the longitudinal axis, wherein the first driving face is connected to a first angle, wherein the first driving face does not intersect with the longitudinal axis, and wherein a side of the first driving face distant to the first end face is located on the reference plane.

10. The anti-slip fastener driver as claimed in claim 9, wherein the outer periphery of the driving portion surrounding the longitudinal axis further includes a second peripheral face extending in a direction parallel to the longitudinal axis, wherein the end of the driving portion opposite to the shank further includes a second end face connected to the second peripheral face, wherein the second peripheral face is contiguous to the first peripheral face, wherein the second end face includes a second side and a second angle located outside of the second side, wherein the second side is located on the reference plane, wherein an end of the second side is adjacent to the longitudinal axis and has an end point not located on the longitudinal axis, wherein another end of the second side opposite to the longitudinal axis is connected to the second peripheral side, and wherein the second angle is located between the reference plane and the shank.

11. The anti-slip fastener driver as claimed in claim 10, wherein the outer periphery of the driving portion surrounding the longitudinal axis includes a third peripheral face, a fourth peripheral face, a fifth peripheral face, and a sixth peripheral face, wherein each of the third peripheral face, the fourth peripheral face, the fifth peripheral face, and the sixth peripheral face extends in a direction parallel to the longitudinal axis,
wherein the end of the driving portion opposite to the shank includes a third end face, a fourth end face, a fifth end face, and a sixth end face, wherein the third end face is connected to the third peripheral face, wherein the third peripheral face is contiguous to the second peripheral face and is located on a side of the second peripheral face opposite to the first peripheral face, wherein the third end face includes a third side and a third angle located outside of the third side, wherein the third side is located on the reference plane, wherein an end of the third side adjacent to the longitudinal axis has an end point located outside of the longitudinal axis, wherein another end of the third side opposite to the longitudinal axis is connected to the third peripheral face, wherein the third angle is located between the reference plane and the shank,
wherein the fourth end face is connected to the fourth peripheral face, wherein the fourth peripheral face is contiguous to the third peripheral face and is located on a side of the third peripheral face opposite to the second peripheral face, wherein the fourth peripheral face is parallel to the first peripheral face, wherein the fourth end face includes a fourth side and a fourth angle located outside of the fourth side, wherein the fourth side is located on the reference plane, wherein an end of the fourth side adjacent to the longitudinal axis has an end point is located outside of the longitudinal axis, wherein another end of the fourth side opposite to the longitudinal axis is connected to the fourth peripheral face, wherein the fourth angle is located between the reference plane and the shank,
wherein the fifth end face is connected to the fifth peripheral face, wherein the fifth peripheral face is contiguous to the fourth peripheral face and is located on a side of the fourth peripheral face opposite to the third peripheral face, wherein the fifth peripheral face is parallel to the second peripheral face, wherein the fifth end face includes a fifth side and a fifth angle located outside of the fifth side, wherein the fifth side is located on the reference plane, wherein an end of the fifth side is adjacent to the longitudinal axis and has an end point located outside of the longitudinal axis, wherein another end of the fifth side opposite to the longitudinal axis is connected to the fifth peripheral face, wherein the fifth angle is located between the reference plane and the shank,
wherein the sixth end face is connected to the sixth peripheral face, wherein the sixth peripheral face is located between the first peripheral face and the fifth peripheral face, wherein the sixth peripheral face is parallel to the third peripheral face, wherein the sixth end face includes a sixth side and a sixth angle located outside of the sixth side, wherein the sixth side is located on the reference plane, wherein an end of the sixth side is adjacent to the longitudinal axis and has an end point located outside of the longitudinal axis, wherein another end of the sixth side opposite to the longitudinal axis is connected to the sixth peripheral face, wherein the sixth angle is located between the reference plane and the shank,
wherein the second end face is located on a side of the first driving face opposite to the first end face and is not connected to the first driving face, wherein the second side is located on a side of the second end face adjacent to the first driving face, the third end face is connected to a second driving face extending in a direction parallel to the longitudinal axis, wherein the second driving face is connected to the third angle, wherein the second driving face does not intersect with the longitudinal axis, wherein a side of the second driving face distant to the third end face is located on the reference plane, wherein the fourth end face is located on a side of the second driving face opposite to the third end face and does not intersect with the second driving face, wherein the fourth side is located on a side of the fourth end face adjacent to the second driving face, wherein the fifth end face is connected to a third driving face extending in a direction parallel to the longitudinal axis, wherein the third driving face is connected to the fifth angle, wherein the third driving face does not intersect with the longitudinal axis, wherein a side of the third driving face distant to the fifth end face is located on the reference plane, wherein the sixth end face is located on a side of the third driving face opposite to the fifth end face and does not intersect with the third driving face, wherein the sixth side is located on a side of the sixth end face adjacent to the third driving face,
wherein the second end face is connected to a fourth driving face extending in a direction parallel to the longitudinal axis, wherein the fourth driving face is connected to the second angel, wherein the fourth driving face does not intersect with the longitudinal axis, wherein a side of the fourth driving face distant to the second end face is located on the reference plane, wherein the third end face is located on a side of the fourth driving face opposite to the first end face and does not intersect with the fourth driving face, wherein the third side is located on a side of the third end face adjacent to the fourth driving face,
wherein the fourth end face is connected to a fifth driving face extending in a direction parallel to the longitudinal axis, wherein the fifth driving face is connected to the fourth angle and dose not intersect with the longitudinal axis, wherein a side of the fifth driving face distant to the fourth end face is located on the reference plane, wherein the fifth end face is located on a side of the fifth driving face opposite to the fourth end face and does not intersect with the fifth driving face,
wherein the fifth side is located on a side of the fifth end face adjacent to the fifth driving face, wherein the sixth end face is connected to a sixth driving face extending in a direction parallel to the longitudinal axis, wherein the sixth driving face is connected to the sixth angle, wherein the sixth driving face does not intersect with the longitudinal axis, wherein a side of the sixth driving face distant to the sixth end face is located on the reference plane, wherein the first end face is located on a side of the sixth driving face opposite to the sixth end face and does not intersect with the sixth driving face, and wherein the first side is located on a side of the first end face adjacent to the sixth driving face.

12. The anti-slip fastener driver as claimed in claim 11, wherein the end of the driving portion opposite to the shank includes a seventh end face, wherein the seventh end face is a planar face extending perpendicularly to the longitudinal axis and is located on the reference plane, wherein the seventh end face is connected to the first end face, the first driving face, the second end face, the second driving face, the third end face, the third driving face, the fourth end face, the fourth driving face, the fifth end face, the fifth driving face, the sixth end face, and the sixth driving face, and wherein an outer periphery of the seventh end face surrounding the longitudinal axis is connected to the first peripheral face, the second peripheral face, the third peripheral face, the fourth peripheral face, the fifth peripheral face, and the sixth peripheral face.

13. The anti-slip fastener driver as claimed in claim 9, wherein the end of the driving portion opposite to the shank includes a hole centered at the longitudinal axis and extending along the longitudinal axis, wherein a side of the first end face opposite to the first peripheral face is connected to the hole, and wherein the end of the first side adjacent to the longitudinal axis and an end of the first driving face adjacent to the longitudinal axis are connected to the hole.

14. The anti-slip fastener driver as claimed in claim 13, wherein the outer periphery of the driving portion surrounding the longitudinal axis further includes a second peripheral face extending in a direction parallel to the longitudinal axis, wherein the end of the driving portion opposite to the shank further includes a second end face connected to the second peripheral face, wherein a side of the second end face opposite to the second peripheral face is connected to the hole, wherein the second peripheral face is contiguous to the first peripheral face, wherein the second end face includes a second side and a second angle located outside of the second side, wherein the second side is located on the reference plane, wherein an end of the second side is adjacent to the longitudinal axis and has an end point not located on the longitudinal axis, wherein the end of the second side adjacent to the longitudinal axis is connected to the hole, wherein another end of the second side opposite to the longitudinal axis is connected to the second peripheral side, and wherein the second angle is located between the reference plane and the shank.

15. The anti-slip fastener driver as claimed in claim 14, the outer periphery of the driving portion surrounding the longitudinal axis further includes a third peripheral face, a fourth periphery face, a fifth peripheral face, and a sixth peripheral face, wherein each of the third peripheral face, the fourth peripheral face, the fifth peripheral face, and the sixth peripheral face extends in a direction parallel to the longitudinal axis,
wherein the end of the driving portion opposite to the shank further includes a third end face, a fourth end face, a fifth end face, and a sixth end face, wherein the third end face is connected to the third peripheral face, wherein the third peripheral face is contiguous to the second peripheral face and is located on a side of the second peripheral face opposite to the first peripheral face, wherein the third end face includes a third side and a third angle located outside of the third side, wherein the third side is located on the reference plane, wherein an end of the third side is adjacent to the longitudinal axis and has an end not located on the longitudinal axis, wherein another end of the third side opposite to the longitudinal axis is connected to the third peripheral face, wherein the third angle is located between the reference plane and the shank,
wherein the fourth end face is connected to the fourth peripheral face, wherein the fourth peripheral face is contiguous to the third peripheral face and is located on a side of the third peripheral face opposite to the second peripheral face, wherein the fourth peripheral face is parallel to the first peripheral face, wherein the fourth end face includes a fourth side and a fourth angle located outside of the fourth side, wherein the fourth side is located on the reference plane, wherein an end of the fourth side is adjacent to the longitudinal axis and has an end point not located on the longitudinal axis, wherein another end of the fourth side opposite to the longitudinal axis is connected to the fourth peripheral face, wherein the fourth angle is located between the reference plane and the shank,
wherein the fifth end face is connected to the fifth peripheral face, wherein the fifth peripheral face is contiguous to the fourth peripheral face and is located on a side of the fourth peripheral face opposite to the third peripheral face, wherein the fifth peripheral face is parallel to the second peripheral face, wherein the fifth end face includes a fifth side and a fifth angle located outside of the fifth side, wherein the fifth side is located on the reference plane, wherein an end of the fifth side is adjacent to the longitudinal axis and has an end not located on the longitudinal axis, wherein another end of the fifth side opposite to the longitudinal axis is connected to the fifth peripheral face, wherein the fifth angle is located between the reference plane and the shank,
wherein the sixth end face is connected to the sixth peripheral face, wherein the sixth peripheral face is located between the first peripheral face and the fifth peripheral face, wherein the sixth peripheral face is parallel to the third peripheral face, wherein the sixth end face includes a sixth side and a sixth angle located outside of the sixth side, wherein the sixth side is located on the reference plane, wherein an end of the sixth side is adjacent to the longitudinal axis and has an end point not located on the longitudinal axis, wherein another end of the sixth side opposite to the longitudinal axis is connected to the sixth peripheral face, wherein the sixth angle is located between the reference plane and the shank,
wherein the second end face is located on a side of the first driving face opposite to the first end face and does not intersect with the first driving face, wherein the second side is located on a side of the second end face adjacent to the first driving face, wherein the third end face is connected to a second driving face extending in a direction parallel to the longitudinal axis, wherein the second driving face is connected to the third angle, wherein the second driving face does not intersect with the longitudinal axis, wherein a side of the second driving face distant to the third end face is located on the reference plane, wherein the fourth side is located on a side of the second driving face opposite to the third end face and does not intersect with the second driving face, wherein the fourth side is located on a side of the fourth end face adjacent to the second driving face, wherein the fifth end face is connected to a third driving face extending in a direction parallel to the longitudinal axis, wherein the third driving face is connected to the fifth angle, wherein the third driving face does not intersect with the longitudinal axis, wherein a side of the third driving face distant to the fifth end face is located on the reference plane, wherein the sixth side is located on a side of the third driving face opposite to the fifth end face and does not intersect with the third driving face, wherein the sixth side is located on a side of the sixth end face adjacent to the third driving face,
wherein the second end face is connected to a fourth driving face extending in a direction parallel to the longitudinal axis, wherein the fourth driving face is connected to the second angel, wherein the fourth driving face does not intersect with the longitudinal axis, wherein a side of the fourth driving face distant to the second end face is located on the reference plane, wherein the third side is located on a side of the fourth driving face opposite to the first end face and does not intersect with the fourth driving face, wherein the third side is located on a side of the third end face adjacent to the fourth driving face, wherein the fourth end face is connected to a fifth driving face extending in a direction parallel to the longitudinal axis, wherein the fifth driving face is connected to the fourth angle, wherein the fifth driving face does not intersect with the longitudinal axis, wherein a side of the fifth driving face distant to the fourth end face is located on the reference plane, wherein the fifth end face is located on a side of the fifth driving face opposite to the fourth end face and does not intersect with the fifth driving face, wherein the fifth side is located on a side of the fifth end face adjacent to the fifth driving face,
wherein the sixth end face is connected to a sixth driving face extending in a direction parallel to the longitudinal axis, wherein the sixth driving face is connected to the sixth angle and does not intersect with the longitudinal axis, wherein a side of the sixth driving face distant to the sixth end face is located on the reference plane, wherein the first end face is located on a side of the sixth driving face opposite to the sixth end face and does not intersect with the sixth driving face, wherein the first side is located on a side of the first end face adjacent to the sixth driving face, wherein an end of the fourth driving face adjacent to the longitudinal axis is connected to the hole, wherein a side of the third end face opposite to the third peripheral face is connected to the hole, wherein an end of the third side adjacent to the longitudinal axis and an end of the second driving face adjacent to the longitudinal axis are connected to the hole, wherein a side of the fourth end face opposite to the fourth peripheral face is connected to the hole, wherein an end of the fourth side adjacent to the longitudinal axis and an end of the fifth driving face adjacent to the longitudinal axis are connected to the hole, wherein a side of the fifth end face opposite to the fifth peripheral face is connected to the hole, wherein an end of the fifth side adjacent to the longitudinal axis and an end of the third driving face adjacent to the longitudinal axis are connected to the hole, wherein a side of the sixth end face opposite to the sixth peripheral face is connected to the hole, and wherein an end of the sixth side adjacent to the longitudinal axis and an end of the sixth driving face adjacent to the longitudinal axis are connected to the hole.

16. The anti-slip fastener driver as claimed in claim 15, wherein the end of the driving portion opposite to the shank includes a seventh end face, an eighth end face, a ninth end face, a tenth end face, an eleventh end face, and a twelfth end face, wherein each of the seventh, eighth, ninth, tenth, eleventh, and twelfth end faces is a planar face extending perpendicularly to the longitudinal axis and is located on the reference plane,
wherein the seventh end face is located on a side of the first end face opposite to the first driving face, wherein an end of the seventh end face is connected to the hole, wherein another end of the seventh end face is connected to the first peripheral face, wherein a side of the seventh end face is connected to the first end face, wherein the first side is formed between the first end face and the seventh end face,
wherein the eighth end face is located on a side of the second end face opposite to the fourth driving face, wherein an end of the eighth end face is connected to the hole, wherein another end of the eighth end face is connected to the second peripheral face, wherein a side of the eighth end face is connected to the second end face, wherein the second side is formed between the second end face and the eighth end face,
wherein the ninth end face is located on a side of the third end face opposite to the second driving face, wherein an end of the ninth end face is connected to the hole, wherein another end of the ninth end face is connected to the third peripheral face, wherein a side of the ninth end face is connected to the third end face, wherein the third side is formed between the third end face and the ninth end face,
wherein the tenth end face is located on a side of the fourth end face opposite to the fifth driving face, wherein an end of the tenth end face is connected to the hole, wherein another end of the tenth end face is connected to the fourth peripheral face, wherein a side of the tenth end face is connected to the fourth end face, wherein the fourth side is formed between the fourth end face and the tenth end face,
wherein the eleventh end face is located on a side of the fifth end face opposite to the third driving face, wherein an end of the eleventh end face is connected to the hole, wherein another end of the eleventh end face is connected to the fifth peripheral face, wherein a side of the eleventh end face is connected to the fifth end face, wherein the fifth side is formed between the fifth end face and the eleventh end face,
wherein the twelfth end face is located on a side of the sixth end face opposite to the sixth driving face, wherein an end of the twelfth end face is connected to the hole, wherein another end of the twelfth end face is connected to the sixth peripheral face, wherein a side of the twelfth end face is connected to the sixth end face, wherein the sixth side is formed between the sixth end face and the twelfth end face.

17. The anti-slip fastener driver as claimed in claim 9, wherein the first peripheral face has a lateral width in a radial direction perpendicular to the longitudinal axis, wherein an end of the first side adjacent to the longitudinal axis and another end of the first side connected to the first peripheral face have a first length therebetween, and wherein the first length is smaller than 0.5 times the lateral width.

18. The anti-slip fastener driver as claimed in claim 11, wherein the first peripheral face has a lateral width in a radial direction perpendicular to the longitudinal axis, wherein an end of the first side adjacent to the longitudinal axis and another end of the first side connected to the first peripheral face have a first length therebetween, wherein an end of the second side adjacent to the longitudinal axis and another end of the second side connected to the second peripheral face have a second length therebetween, wherein an end of the third side adjacent to the longitudinal axis and another end of the third side connected to the third peripheral face have a third length therebetween, wherein an end of the fourth side adjacent to the longitudinal axis and another end of the fourth side connected to the fourth peripheral face have a fourth length therebetween, wherein an end of the fifth side adjacent to the longitudinal axis and another end of the fifth side connected to the fifth peripheral face have a fifth length therebetween, wherein an end of the sixth side adjacent to the longitudinal axis and another end of the sixth side connected to the sixth peripheral face have a sixth length therebetween, and wherein each of the first length, the second length, the third length, the fourth length, the fifth length, and the sixth length is smaller than 0.5 times the lateral width.

19. The anti-slip fastener driver as claimed in claim 12, wherein a side of the first driving face connected to the seventh end face intersects with the first side, wherein the side of the first driving face and the first side have a first angle therebetween, wherein a side of the fourth driving face connected to the seventh end face intersects with the second side, wherein the side of the fourth driving face and the second side have a second angle therebetween, wherein a side of the second driving face connected to the seventh end face intersects with the third side, wherein the side of the second driving face and the third side have a third angle therebetween, wherein a side of the fifth driving face connected to the seventh end face intersects with the fourth side, wherein the side of the fifth driving face and the fourth side have a fourth angle therebetween, wherein a side of the third driving face connected to the seventh end face intersects with the fifth side, wherein the side of the third driving face and the fifth side have a fifth angle therebetween, wherein a side of the sixth driving face connected to the seventh end face intersects with the sixth side, wherein the side of the sixth driving face and the sixth side have a sixth angle therebetween, and wherein each of the first angle, the second angle, the third angle, the fourth angle, the fifth angle, and the sixth angle is larger than 80°.

20. The anti-slip fastener driver as claimed in claim 2, wherein the end of the first side adjacent to the longitudinal axis has an end point not located on the longitudinal axis, and wherein the first driving face does not intersect with the first side.

21. The anti-slip fastener driver as claimed in claim 20, wherein the outer periphery of the driving portion surrounding the longitudinal axis further includes a second peripheral face extending in a direction parallel to the longitudinal axis, wherein the end of the driving portion opposite to the shank further includes a second end face connected to the second peripheral face, wherein the second peripheral face is contiguous to the first peripheral face, wherein the second end face includes a second side and a second angle located outside of the second side, wherein an end of the first side is adjacent to the longitudinal axis and has an end point not located on the longitudinal axis, wherein the end of the second side adjacent to the longitudinal axis is connected to the first driving face, wherein another end of the second side opposite to the longitudinal axis is connected to the second peripheral side, and wherein the second angle is located between the reference plane and the shank.

22. The anti-slip fastener driver as claimed in claim 21, wherein the outer periphery of the driving portion surrounding the longitudinal axis further includes a third peripheral face, a fourth peripheral face, a fifth peripheral face, and a sixth peripheral face, wherein each of the third peripheral face, the fourth peripheral face, the fifth peripheral face, and the sixth peripheral face extends in a direction parallel to the longitudinal axis,
wherein the end of the driving portion opposite to the shank includes a third end face, a fourth end face, a fifth end face, and a sixth end face, wherein the third end face is connected to the third peripheral face, wherein the third peripheral face is contiguous to the second peripheral face and is located on a side of the second peripheral face opposite to the first peripheral face, wherein the third end face includes a third side and a third angle located outside of the third side, wherein the third side is located on the reference plane, wherein an end of the third side is adjacent to the longitudinal axis and has an end point not located on the longitudinal axis, wherein another end of the third side opposite to the longitudinal axis is connected to the third peripheral face, wherein the third angle is located between the reference plane and the shank,
wherein the fourth end face is connected to the fourth peripheral face, wherein the fourth peripheral face is contiguous to the third peripheral face and is located on a side of the third peripheral face opposite to the second peripheral face, wherein the fourth peripheral face is parallel to the first peripheral face, wherein the fourth end face includes a fourth side and a fourth angle located outside of the fourth side, wherein the fourth side is located on the reference plane, wherein an end of the fourth side is adjacent to the longitudinal axis and has an end point not located on the longitudinal axis, wherein another end of the fourth side opposite to the longitudinal axis is connected to the fourth peripheral face, wherein the fourth angle is located between the reference plane and the shank,
wherein the fifth end face is connected to the fifth peripheral face, wherein the fifth peripheral face is contiguous to the fourth peripheral face and is located on a side of the fourth peripheral face opposite to the third peripheral face, wherein the fifth peripheral face is parallel to the second peripheral face, wherein the fifth end face includes a fifth side and a fifth angle located outside of the fifth side, wherein the fifth side is located on the reference plane, wherein an end of the fifth side is adjacent to the longitudinal axis and has an end point not located on the longitudinal axis, wherein another end of the fifth side opposite to the longitudinal axis is connected to the fifth peripheral face, wherein the fifth angle is located between the reference plane and the shank,
wherein the sixth end face is connected to the sixth peripheral face, wherein the sixth peripheral face is located between the first peripheral face and the fifth peripheral face, wherein the sixth peripheral face is parallel to the third peripheral face, wherein the sixth end face includes a sixth side and a sixth angle located outside of the sixth side, wherein the sixth side is located on the reference plane, wherein an end of the sixth side is adjacent to the longitudinal axis and has an end point not located on the longitudinal axis, wherein another end of the sixth side opposite to the longitudinal axis is connected to the sixth peripheral face, wherein the sixth angle is located between the reference plane and the shank,
wherein the third end face is connected to a second driving face extending in a direction parallel to the longitudinal axis, wherein the second driving face is connected to the third angle, wherein the second driving face has an angle located on the longitudinal axis, wherein a side of the second driving face distant to the third end face is located on the reference plane, wherein an end of the fourth side adjacent to the longitudinal axis is connected to the second driving face, wherein the second driving face does not intersect with the third side, wherein the fifth end face is connected to a third driving face extending in a direction parallel to the longitudinal axis, wherein the third driving face is connected to the fifth angle, wherein the third driving face has an angle located on the longitudinal axis, wherein a side of the third driving face distant to the fifth end face is located on the reference plane, wherein an end of the sixth side adjacent to the longitudinal axis is connected the third driving face, wherein the third driving face does not intersect with the fifth side,
wherein the second end face is connected to a fourth driving face extending in a direction parallel to the longitudinal axis, wherein the fourth driving face is connected to the second angel, wherein the fourth driving face has an angle located on the longitudinal axis, wherein a side of the fourth driving face distant to the second end face is located on the reference plane, wherein an end of the third side adjacent to the longitudinal axis is connected to the fourth driving face, wherein the fourth driving face does not intersect with the second side, wherein the fourth end face is connected to a fifth driving face extending in a direction parallel to the longitudinal axis, wherein the fifth driving face is connected to the fourth angle, wherein the fifth driving face has an angle located on the longitudinal axis, wherein a side of the fifth driving face distant to the fourth end face is located on the reference plane, wherein an end of the fifth side adjacent to the longitudinal axis is connected to the fifth driving face, wherein the fifth driving face does not intersect with the fourth side, wherein the sixth end face is connected to a sixth driving face extending in a direction parallel to the longitudinal axis, wherein the sixth driving face is connected to the sixth angle, wherein the sixth driving face has an angle located on the longitudinal axis, wherein a side of the sixth driving face distant to the sixth end face is located on the reference plane, wherein the end of the first side adjacent to the longitudinal axis is connected to the sixth driving face, and wherein the sixth driving face does not intersect with the sixth side.

23. The anti-slip fastener driver as claimed in claim 22, wherein the end of the driving portion opposite to the shank includes a seventh end face, an eighth end face, a ninth end face, a tenth end face, an eleventh end face, and a twelfth end face, wherein each of the seventh, eighth, ninth, tenth, eleventh, and twelfth end faces is a planar face extending perpendicularly to the longitudinal axis and is located on the reference plane,
wherein the seventh end face is connected to the first peripheral face, the first end face, and the sixth driving face, wherein the first side is formed between the first end face and the seventh end face,
wherein the eighth end face is connected to the second peripheral face, the second end face, and the first driving face, wherein the second side is formed between the second end face and the eighth end face,
wherein the ninth end face is connected to the third peripheral face, the third end face, and the fourth driving face, wherein the third side is formed between the third end face and the ninth end face,
wherein the tenth end face is connected to the fourth peripheral face, the fourth end face, and the second driving face, wherein the fourth side is formed between the fourth end face and the tenth end face,
wherein the eleventh end face is connected to the fifth peripheral face, the fifth end face, and the fifth driving face, wherein the fifth side is formed between the fifth end face and the eleventh end face,
wherein the twelfth end face is connected to the sixth peripheral face, the sixth end face, and the third driving face, wherein the sixth side is formed between the sixth end face and the twelfth end face.

24. The anti-slip fastener driver as claimed in claim 22, wherein each of the first, second, third, fourth, fifth, and sixth end faces is a slant face at a non-parallel angle to the reference plane.

25. The anti-slip fastener driver as claimed in claim 22, wherein each two adjacent ones of the first, second, third, fourth, fifth, and sixth peripheral faces have an inner angle of 120° therebetween.

26. An anti-slip fastener driver comprising:
a shank; and
a driving portion formed on an end of the shank and defining a longitudinal axis, wherein the driving portion includes an outer periphery surrounding the longitudinal axis and having a first peripheral face, a second peripheral face, and a third peripheral face, wherein an end of the driving portion opposite to the shank includes an end face connected to the first, second, and third peripheral faces, wherein the second peripheral face is contiguous to the first peripheral face, wherein the third peripheral face is contiguous to the second peripheral face and is located on a side of the second peripheral face opposite to the first peripheral face, wherein the end face includes a first angle and a second angle, wherein the first angle is located on an intersection between the first peripheral face and the second peripheral face, wherein the second angle is located between an intersection between the second peripheral face and the third peripheral face, wherein the driving portion includes a first groove, wherein an end of the first groove is connected to the end face, wherein another end of the first groove is connected to the second peripheral face, wherein the end of the first groove connected to the end face forms a first edge, wherein an end of the first edge has an end point located on the second angle, and wherein the first edge does not intersect with the first angle.

27. The anti-slip fastener driver as claimed in claim 26, wherein the outer periphery of the driving portion surrounding the longitudinal axis further includes a fourth peripheral face, a fifth peripheral face, and a sixth peripheral face, wherein each of the first, second, third, fourth, fifth, and sixth peripheral faces extends in a direction parallel to the longitudinal axis, wherein the end face is connected to the first, second, third, fourth, fifth, and sixth peripheral faces, wherein the fourth peripheral face is contiguous to the third peripheral face and is located on a side of the third peripheral face opposite to the second peripheral face, wherein the fourth peripheral face is parallel to the first peripheral face, wherein the fifth peripheral face is contiguous to the fourth peripheral face and is located on a side of the fourth peripheral face opposite to the third peripheral face, wherein the fifth peripheral face is parallel to the second peripheral face, wherein the sixth peripheral face is located between the first peripheral face and the fifth peripheral face, wherein the sixth peripheral face is parallel to the third peripheral face,
wherein the end face further includes a third angle, a fourth angle, a fifth angle, and a sixth angle, wherein the third angle is located on an intersection between the third peripheral face and the fourth peripheral face, wherein the fourth angle is located on an intersection between the fourth peripheral face and the fifth peripheral face, wherein the fifth angle is located on an intersection between the third peripheral face and the sixth peripheral face, wherein the sixth angle is located on an intersection between the sixth peripheral face and the first peripheral face,
wherein the driving portion further includes a second groove and a third groove, wherein an end of the second groove is connected to the end face, wherein another end of the second groove is connected to the fourth peripheral face, wherein the end of the second groove connected to the end face forms a second edge, wherein an end of the second edge is located on the fourth angle, wherein the second edge does not intersect with the third angle, wherein an end of the third groove is connected to the end face, wherein another end of the third groove is connected to the sixth peripheral face, wherein the end of the third groove connected to the end face forms a third edge, wherein an end of the third edge has an end point located on the sixth angle, and wherein the second edge does not intersect with the fifth angle.

28. The anti-slip fastener driver as claimed in claim 27, wherein the driving portion further includes a fourth groove, a fifth groove, and a sixth groove, wherein an end of the fourth groove is connected to the end face, wherein another end of the fourth groove is connected to the first peripheral face, wherein the end of the fourth groove connected to the end face forms a fourth edge, wherein an end of the fourth edge has an end point located on the first angle, wherein the fourth edge does not intersect with the sixth angle, wherein an end of the fifth groove is connected to the end face, wherein another end of the fifth groove is connected to the third peripheral face, wherein the end of the fifth groove connected to the end face forms a fifth edge, wherein an end of the fifth edge is located on the third angle, wherein the fifth edge does not intersect with the second angle, wherein an end of the sixth groove is connected to the end face, wherein another end of the sixth groove is connected to the fifth peripheral face, wherein the end of the sixth groove connected to the end face forms a sixth edge, wherein an end of the sixth edge has an end point located on the fifth angle, and wherein the sixth edge does not intersect with the fourth angle.

29. The anti-slip fastener driver as claimed in claim 28, wherein each two adjacent ones of the first, second, third, fourth, fifth, and sixth peripheral faces have an inner angle of 120° therebetween, wherein the first, second, third, fourth, fifth, and sixth edges are not connected to each other, and wherein each of the first, second, third, fourth, fifth, and sixth edges is arcuate.

30. An anti-slip fastener driver comprising:
a shank; and
a driving portion formed on an end of the shank and defining a longitudinal axis, wherein the driving portion includes an outer periphery surrounding the longitudinal axis and having a first peripheral face, wherein an end of the driving portion opposite to the shank includes a front conical face and a first end face, wherein the front conical face is a conical face centered at the longitudinal axis, wherein the first end face is connected to the first peripheral face, wherein the first end face includes a first side and a first angle not located on the first side, wherein the first side is located on the front conical face, wherein an end of the first side is adjacent to the longitudinal axis, wherein another end of the first side opposite to the longitudinal axis is connected to the first peripheral face, and wherein the first angle is located between the front conical face and the shank along the longitudinal axis.

31. The anti-slip fastener driver as claimed in claim 30, wherein the first peripheral face extending in a direction parallel to the longitudinal axis, wherein an end of the first side adjacent to the longitudinal axis has an end point not locate don the longitudinal axis, wherein the first end face is connected to a first driving face extending in a direction parallel to the longitudinal axis, wherein the first driving face is connected to the first angle, wherein the first driving face does not intersect with the longitudinal axis, and wherein a side of the first driving face distant to the first end face is located on the front conical face.

32. The anti-slip fastener driver as claimed in claim 31, wherein the outer periphery of the driving portion surrounding the longitudinal axis further includes a second peripheral face extending in a direction parallel to the longitudinal axis, wherein the end of the driving portion opposite to the shank further includes a second end face connected to the second peripheral face, wherein the second peripheral face is contiguous to the first peripheral face, wherein the second end face includes a second side and a second angle located outside of the second side, wherein the second side is located on the front conical face, wherein an end of the second side is adjacent to the longitudinal axis and has an end point not located on the longitudinal axis, wherein another end of the second side opposite to the longitudinal axis is connected to the second peripheral face, and wherein the second angle is located between the front conical face and the shank along the longitudinal axis.

33. The anti-slip fastener driver as claimed in claim 32, wherein the outer periphery of the driving portion surrounding the longitudinal axis further includes a third peripheral face, a fourth peripheral face, a fifth peripheral face, and a sixth peripheral face, wherein each of the third, fourth, fifth, and sixth peripheral faces extends in a direction parallel to the longitudinal axis,
wherein the end of the driving portion opposite to the shank further includes a third end face, a fourth end face, a fifth end face, and a sixth end face, wherein the third end face is connected to the third peripheral face, wherein the third peripheral face is contiguous to the second peripheral face and is located on a side of the second peripheral face opposite to the first peripheral face, wherein the third end face includes a third side and a third angle located outside of the third side, wherein the third side is located on the front conical face, wherein an end of the third side is adjacent to the longitudinal axis and has an end point not located on the longitudinal axis, wherein another end of the third side opposite to the longitudinal axis is connected to the third peripheral face, wherein the third angle is located between the front conical face and the shank along the longitudinal axis,
wherein the fourth end face is connected to the fourth peripheral face, wherein the fourth peripheral face is contiguous to the third peripheral face and is located on a side of the third peripheral face opposite to the second peripheral face, wherein the fourth peripheral face is parallel to the first peripheral face, wherein the fourth end face includes a fourth side and a fourth angle located outside of the fourth side, wherein the fourth side is located on the front conical face, wherein an end of the fourth side is adjacent to the longitudinal axis and has an end point not located on the longitudinal axis, wherein another end of the fourth side opposite to the longitudinal axis is connected to the fourth peripheral face, wherein the fourth angle is located between the front conical face and the shank along the longitudinal axis,
wherein the fifth end face is connected to the fifth peripheral face, wherein the fifth peripheral face is contiguous to the fourth peripheral face and is located on a side of the fourth peripheral face opposite to the third peripheral face, wherein the fifth peripheral face is parallel to the second peripheral face, wherein the fifth end face includes a fifth side and a fifth angle located outside of the fifth side, wherein the fifth side is located on the front conical face, wherein an end of the fifth side is adjacent to the longitudinal axis and has an end point not located on the longitudinal axis, wherein another end of the fifth side opposite to the longitudinal axis is connected to the fifth peripheral face, wherein the fifth angle is located between the front conical face and the shank along the longitudinal axis,
wherein the sixth end face is connected to the sixth peripheral face, wherein the sixth peripheral face is located between the first peripheral face and the fifth peripheral face, wherein the sixth peripheral face is parallel to the third peripheral face, wherein the sixth end face includes a sixth side and a sixth angle located outside of the sixth side, wherein the sixth side is located on the front conical face, wherein an end of the sixth side is adjacent to the longitudinal axis and has an end point not located on the longitudinal axis, wherein another end of the sixth side opposite to the longitudinal axis is connected to the sixth peripheral face, wherein the sixth angle is located between the front conical face and the shank along the longitudinal axis, wherein the second end face is located on a side of the first driving face opposite to the first end face and does not intersect with the first driving face, wherein the second side is located on a side of the second end face adjacent to the first driving face,
wherein the third end face is connected to a second driving face extending in a direction parallel to the longitudinal axis, wherein the second driving face is connected to the third angle, wherein the second driving face does not intersect with the longitudinal axis, wherein a side of the second driving face distant to the third end face is located on the front conical face, wherein the fourth end face is located on a side of the second driving face opposite to the third driving face and does not intersect with the second driving face, wherein the fourth side is located on a side of the fourth end face adjacent to the second driving face,
wherein the fifth end face is connected to a third driving face extending in a direction parallel to the longitudinal axis, wherein the third driving face is connected to the fifth angle, wherein the third driving face does not intersect with the longitudinal axis, wherein a side of the third driving face distant to the fifth end face is located on the front conical face, wherein the sixth end face is located on a side of the third driving face opposite to the fifth end face and dose not intersect with the third driving face, wherein the sixth side is located on a side of the sixth end face adjacent to the third driving face,
wherein the second end face is connected to a fourth driving face extending in a direction parallel to the longitudinal axis, wherein the fourth driving face is connected to the second angle, wherein the fourth driving face does not intersect with the longitudinal axis, wherein a side of the fourth driving face distant to the second end face is located on the front conical face, wherein the third end face is located on a side of the fourth driving face opposite to the first end face and does not intersect with the fourth driving face, wherein the third side is located on a side of the third end face adjacent to the fourth driving face,
wherein the fourth end face is connected to a fifth driving face extending in a direction parallel to the longitudinal axis, wherein the fifth driving face is connected to the fourth angle, wherein the fifth driving face does not intersect with the longitudinal axis, wherein a side of the fifth driving face distant to the fourth end face is located on the front conical face, wherein the fifth end face is located on a side of the fifth driving face opposite to the fourth end face and does not intersect with the fifth driving face, wherein the fifth side is located on a side of the fifth end face adjacent to the fifth driving face,
wherein the sixth end face is connected to a sixth driving face extending in a direction parallel to the longitudinal axis, wherein the sixth driving face is connected to the sixth angle, wherein the sixth driving face does not intersect with the longitudinal axis, wherein a side of the sixth driving face distant to the sixth end face is located on the front conical face, wherein the first end face is located on a side of the sixth driving face opposite to the sixth end face and does not interest with the sixth driving face, and wherein the first side is located on a side of the first end face adjacent to the sixth driving face.

34. The anti-slip fastener driver as claimed in claim 33, wherein the end of the driving portion opposite to the shank has a front face, wherein the front face is a circular face orthogonal to the longitudinal axis and centered at the longitudinal axis, and wherein the front conical face surrounds the front face.

35. The anti-slip fastener driver as claimed in claim 34, wherein each of the first, second, third, fourth, fifth, and sixth end faces is a slant face not perpendicular to the longitudinal axis.

36. The anti-slip fastener driver as claimed in claim 34, wherein each two adjacent ones of the first, second, third, fourth, fifth, and sixth peripheral faces have an inner angle of 120° therebetween.
